(19) United States
(12) Patent Application Publication
(10) Pub. No.: US 2010/0279012 A1
(43) Pub. Date: Nov. 4, 2010

(54) METHOD FOR ADSORBING PLATING CATALYST, METHOD FOR PREPARING SUBSTRATE PROVIDED WITH METAL LAYER, AND PLATING CATALYST SOLUTION USED IN THE SAME

(75) Inventor: Masataka Sato, Ashigarakami-gun (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM CORPORATION, Minato-ku, Tokyo (JP)

(21) Appl. No.: 12/810,806

(22) PCT Filed: Dec. 5, 2008
(86) PCT No.: PCT/JP2008/072115

§ 371 Date: Jun. 25, 2010

(30) Foreign Application Priority Data
Dec. 27, 2007 (JP) 2007-338035
Apr. 18, 2008 (JP) 2008-108577

(51) Int. Cl. B05D 3/10; B01J 23/44; B01J 23/755; B01J 23/745; B01J 23/50; B01J 23/72; B01J 23/75; B01J 21/02; B05D 5/00

(52) U.S. Cl. 427/256; 502/339; 502/337; 502/338; 502/347; 502/345; 502/325; 502/355; 205/136

(57) ABSTRACT

A method for adsorbing a catalyst, including: a step of applying, to a substrate, a photocurable composition which contains a compound having a polymerizable group and a group that is interactive with a plating catalyst or a precursor thereof, and that, when photo-cured, forms a surface-hydrophobic cured material satisfying the following Requirements 1 and 2; a step of curing the curable composition by pattern-wise exposure, a step of removing uncured materials by development; and a step of bringing an aqueous plating catalyst solution containing a plating catalyst or a precursor thereof and an organic solvent into contact with the substrate, wherein when a palladium-containing test liquid is brought into contact with the substrate having the patterned surface-hydrophobic cured material layer formed thereon, A mg/m² and B mg/m², which respectively refer to a palladium adsorption in an area having the surface-hydrophobic cured material layer formed thereon and a palladium adsorption in an area not having the surface-hydrophobic cured material layer formed thereon, satisfy the following relationship Formulae (A) and (B):

Requirement 1: saturated water absorption under the conditions of 25° C. and a relative humidity of 50% is from 0.01 to 5% by mass,

Requirement 2: saturated water absorption under the conditions of 25° C. and a relative humidity of 95% is from 0.05 to 10% by mass,

10 mg/m²≦A≦150 mg/m² Formula (A)

0 mg/m²≦B≦5 mg/m². Formula (B)

### CROSS-REFERENCE TO RELATED APPLICATION

This application is based on and claims priority under 35 USC 119 from Japanese Patent Application Nos. 2007-338035 filed on Dec. 27, 2007 and 2008-108577 filed on April 18, the disclosures of which are incorporated herein by reference in their entireties.

### TECHNICAL FIELD

The present invention relates to a method for adsorbing a plating catalyst to apply a plating catalyst efficiently on to a pattern-wise hydrophobic base material surface, a method for preparing a substrate provided with a metal layer using the method, and a plating catalyst solution preferably used in such a method.

### BACKGROUND ART

Conventionally, a metal wiring substrate having wiring made of a metal pattern formed on an insulating substrate surface has been widely used for electronic members or semiconductor devices.

As a method for preparing such a metal pattern material to be used, a “subtractive method” is mainly used. This subtractive method includes forming a photosensitive layer that is sensitive to radiation of actinic rays on a metal film that has been formed on a substrate, exposing the photosensitive layer to light in an image-wise manner, developing the same to form a resist image, etching the metal film to form a metal pattern, and finally stripping the resist.

As for the metal pattern obtained by the above method, a metal film is adhered to a substrate by an anchoring effect that occurs due to roughness formed on the substrate surface. Therefore, there has been a problem in that high-frequency characteristics of the metal pattern when used as a metal wiring may be deteriorated due to roughness formed in the interface portion of the obtained metal pattern with the substrate. Further, there has been a problem that since the substrate surface needs to be treated with a strong acid such as chromium acid to be roughened, it is necessary to perform a complicated process in order to obtain a metal pattern having excellent adhesiveness between a metal film and a substrate.

In order to solve the above-described problems, there has been proposed a method for improving the adhesiveness between a substrate and a metal film without roughening the substrate surface, which includes subjecting the substrate surface to a plasma treatment and introducing a functional group that initiates polymerization to the substrate surface, polymerizing a monomer from the functional group, and then forming a surface graft polymer having a polar group on the substrate surface (see, for example, Advanced Materials 2000, No. 20, pages 1481-1494). However, this method has a problem that since the graft polymer has a polar group, absorption or desorption of moisture due to changes in temperature or humidity tends to occur, which may cause deformation of the obtained metal film or the substrate.

Examples of a method for forming a metal film on various substrate surfaces include methods using electroless plating, electroplating, or the like, and by controlling the composition of a plating bath or the plating condition, any type of a metal film can be formed.

As a resin material for carrying out partial plating, there has been proposed a thermosensitive resin composition having a polymerizable group (see, for example, Japanese Patent Application Laid-Open (JP-A) No. 11-350149). However, since this resin material is thermosetting, it is difficult to form a fine electrical wiring such as, for example, those having a line-and-space of 10 μm or less, by using a full-additive method, and it has been hard to say that as for the adhesion force of a metal layer onto a smooth surface, there is sufficient performance in the case of applications to electrical wiring.

As a method for forming a pattern which is useful in the full-additive method, preferred is a method in which a catalyst adsorbent hydrophobic pattern resin layer is formed on a hydrophobic substrate in order to avoid failures in the step of preparing an electrical wiring by water absorption or electrical failures of the electrical wiring itself. To achieve this method, an area on which the plating catalyst is adhered is pattern-wise formed by using the difference in adsorption properties of the plating catalyst between catalyst-receptive area and the substrate surface not having such characteristics, and then a pattern-wise metal layer can be formed by carrying out plating. However, in this method, the plating catalyst solution is required to employ a liquid penetrating to some extent into the catalyst adsorbent hydrophobic pattern resin layer, and therefore, there has been a problem that the plating solution also penetrates to the hydrophobic substrate surface in addition to such a hydrophobic pattern resin layer, making the pattern plating difficult.

Therefore, it is necessary to carry out complicated steps such as introducing a means for inhibiting adsorption onto a substrate surface to prevent a plating catalyst from adsorption onto a non-pattern portion when pattern plating is carried out on a hydrophobic substrate having excellent electrical reliability (see, for example, Japanese Patent Application Laid-Open (JP-A) No. 9-307216). Alternatively, there has been known a method for masking a non-pattern portion with a plating resist while adsorbing the catalyst on the entire surface of a substrate, to carry out plating only on the exposed pattern portion, or the like (see, for example, Japanese Patent Application Laid-Open (JP-A) No. 6-85433). However, a step of removing resist adhesion or metal residues between the wirings is added, which causes a problem of making the process more complicated. Further, there has been known a method for giving adsorption difference by introducing a hydrophilic ion exchange group into a pattern portion (see, for example, Japanese Patent Application Laid-Open (JP-A) No. 2003-166068), but in this case, by carrying out a treatment for giving hydrophilicity, there is a risk that there may occur a problem in the electrical reliability.

Therefore, in order to form a high-precision pattern-wise metal layer in a simple and easy manner by a full-additive method, there has been a demand of a method for adsorbing a plating catalyst selectively in a receiving region on a substrate having a hydrophobic plating catalyst receiving region and a hydrophobic substrate surface exposing region.

### DISCLOSURE OF INVENTION

### Problem(s) to be Solved by the Invention

The present invention has been made taking into consideration the drawbacks of the above-described conventional techniques, and accordingly, aims to accomplish the following objects.

It is an object of the present invention to provide a method for adsorbing a catalyst which is capable of adsorbing the plating catalyst selectively only on a plating catalyst receiving region in a substrate made by forming a pattern-wise hydrophobic plating catalyst receiving region on a hydrophobic surface, and a method for preparing a substrate provided with a metal layer, which is excellent in adhesiveness between the substrate and the metal layer and is capable of forming a high-precision pattern by the above-described method.

In is another object of the invention to provide a plating catalyst solution which can be preferably used in the method for adsorbing a catalyst and the method for preparing a substrate provided with a metal layer of the invention.

### Means for Solving Problem(s)

The present inventors have made extensive studies concerning the above-described problems, and as a result, they have found that the above-described objects can be accomplished by using a resin composition containing a compound capable of interaction with a plating catalyst or a precursor thereof and a specific aqueous plating solution, thereby completing the present invention.

The representative embodiments of the invention will be described below, but the invention is not intended to be limited thereto.

<1> A method for adsorbing a catalyst, including:

a step of applying, to a substrate, a photocurable composition which contains a compound having a polymerizable group and a functional group that is interactive with a plating catalyst or a precursor thereof, and that, when photo-cured, forms a surface-hydrophobic cured material satisfying the following Requirements 1 and 2;

a step of curing the photocurable composition by pattern-wise exposure, thereby forming a surface-hydrophobic cured material layer on the exposed area;

a step of removing uncured material of the photocurable composition with a developer to form a patterned surface-hydrophobic cured material layer; and

a step of bringing an aqueous plating catalyst solution containing a plating catalyst or a precursor thereof and an organic solvent into contact with the substrate having the patterned surface-hydrophobic cured material layer formed thereon,

wherein, when a palladium-containing test liquid is brought into contact with the substrate having the patterned surface-hydrophobic cured material layer formed thereon, A mg/m² and B mg/m², which respectively refer to a palladium adsorption in an area having the surface-hydrophobic cured material layer formed thereon and a palladium adsorption in an area not having the surface-hydrophobic cured material layer formed thereon, satisfy the following relationship Formulae (A) and (B):

Requirement 1: saturated water absorption under conditions of 25° C. and a relative humidity of 50% is from 0.01 to 5% by mass

Requirement 2: saturated water absorption under conditions of 25° C. and a relative humidity of 95% is from 0.05 to 10% by mass

10 mg/m²≦A≦150 mg/m² Formula (A)

0 mg/m²≦B≦5 mg/m². Formula (B)

<2> The method for adsorbing a catalyst according to <1>, wherein the plating catalyst or precursor thereof is palladium, silver, copper, nickel, aluminum, iron, or cobalt, or a precursor thereof.

<3> A method for adsorbing a catalyst, including:

a step of applying, to a substrate, a photocurable composition which contains a compound having a polymerizable group and a functional group that is interactive with a plating catalyst or a precursor thereof, and that, when photo-cured, forms a surface-hydrophobic cured material satisfying the following Requirements 1 and 2;

a step of curing the photocurable composition by pattern-wise exposure, thereby forming a surface-hydrophobic cured material layer on the exposed area;

a step of removing uncured material of the photocurable composition with a developer to form a patterned surface-hydrophobic cured material layer; and

a step of bringing an aqueous plating catalyst solution containing a plating catalyst or a precursor thereof and an organic solvent into contact with the substrate having the patterned surface-hydrophobic cured material layer formed thereon,

wherein a solvent of a palladium-containing test liquid has an absorption of from 3% to less than 50% relative to the mass of the surface-hydrophobic cured material layer and an absorption of from 0.1% to less than 2.0% relative to the mass of an area not having the surface-hydrophobic cured material layer formed thereon:

Requirement 1: saturated water absorption under conditions of 25° C. and a relative humidity of 50% is from 0.01 to 5% by mass

Requirement 2: saturated water absorption under conditions of 25° C. and a relative humidity of 95% is from 0.05 to 10% by mass

<4> The method for adsorbing a catalyst according to <3>, wherein the plating catalyst or precursor thereof is palladium, silver, copper, nickel, aluminum, iron, or cobalt, or a precursor thereof.

<5> The method for adsorbing a catalyst according to <3> or <4>, wherein, in the step of bringing an aqueous plating catalyst solution containing a plating catalyst or a precursor thereof and an organic solvent into contact with the substrate having the patterned surface-hydrophobic cured material layer formed thereon, C (% by mass) and D (% by mass), which respectively refer to an absorption of palladium plating catalyst relative to the mass of the surface-hydrophobic cured material layer and an absorption of palladium plating catalyst relative to the mass of the area not having the surface-hydrophobic cured material layer formed thereon, satisfy the following relationship Formula (C):

0.002<(D/C)<0.67 Formula (C)

<6> The method for adsorbing a catalyst according to any one of <1> to <5>, further including a step of forming, on a substrate, an adhesion aiding layer containing an active species which generates an active site capable of interacting with a film formed by the photocurable composition, prior to the step of applying the photocurable composition to the substrate.

<7> The method for adsorbing a catalyst according to any one of <1> to <6>, wherein the organic solvent is water-soluble and its content relative to the total amount of the aqueous plating catalyst solution is from 0.5 to 40% by mass.

<8> The method for adsorbing a catalyst according to any one of <1> to <7>, wherein the compound having the polymerizable group and the functional group that is interactive with a plating catalyst or a precursor thereof is a polymer having a polymerizable group and a functional group that is interactive with a plating catalyst or a precursor thereof.

<9> The method for adsorbing a catalyst according to any one of <1> to <8>, wherein the functional group that is interactive with a plating catalyst or a precursor thereof is a nitrogen-containing functional group, an oxygen-containing functional group, or a sulfur-containing functional group.

<10> The method for adsorbing a catalyst according to any one of <1> to <8>, wherein the functional group that is interactive with a plating catalyst or a precursor thereof is an ether group or a cyano group.

<11> The method for adsorbing a catalyst according to any one of <1> to <8>, wherein the functional group that is interactive with a plating catalyst or a precursor thereof is a cyano group.

<12> The method for adsorbing a catalyst according to <8>, wherein the polymer having a polymerizable group and a functional group that is interactive with a plating catalyst or a precursor thereof is a copolymer containing a unit represented by the following Formula (1) and a unit represented by the following Formula (2):

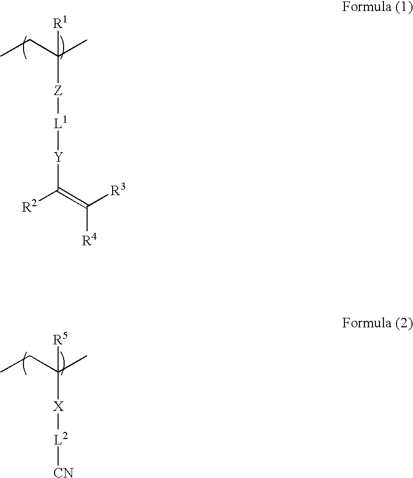

wherein, in Formulae (1) and (2), R¹ to R⁵ each independently represent a hydrogen atom or an alkyl group, X, Y, and Z each independently represent a single bond, a divalent organic group, an ester group, an amide group, or an ether group, and L¹ and L² each independently represent a divalent organic group.

<13> A method for preparing a substrate provided with a patterned metal layer, comprising a step of non-electrically plating the substrate, formed by adsorption of the plating catalyst or precursor thereof on the patterned surface-hydrophobic cured material layer, obtained by the method for adsorbing a catalyst according to any one of <1> to <12>.

<14> The method for preparing a substrate provided with a patterned metal layer according to <13>, further including electrical plating.

<15> An aqueous plating catalyst solution, which is used in the method for adsorbing a catalyst according to any one of <1> to <12> and includes a plating catalyst and a water-soluble organic solvent.

According to the invention, when a pattern is formed by a photocurable composition having hydrophobic catalyst adsorbing capability on a hydrophobic substrate having excellent electrical reliability, and then immersed in a plating solution, by both a functional group allowing the plating catalyst or precursor thereof contained in the catalyst solution to be capable of interacting with the plating catalyst or precursor thereof, introduced into the patterned surface-hydrophobic cured material layer and a function of the aqueous plating solution having excellent penetrating property into a surface-hydrophobic cured material layer, the plating catalyst or precursor thereof selectively and preferentially penetrates into and is adsorbed on the plating catalyst-receptive area having the surface-hydrophobic cured material layer formed thereon. Here, the plating catalyst solution itself penetrates into the surface-hydrophobic cured material layer, in a sufficient amount for the plating catalyst or a precursor thereof to be adsorbed mainly on the periphery of the surface, but it does not penetrate into the non-forming area of the surface-hydrophobic cured material layer, that is, the part on which a hydrophobic substrate or an adhesion aiding layer having formed on a surface of the hydrophobic substrate is exposed, and resultantly, high-precision pattern-wise plating catalyst can be adsorbed without carrying out a complicated treatment. Accordingly, it is believed that a substrate provided with a high-precision pattern-wise metal layer having excellent adhesiveness with the substrate can be simply and easily produced by using a substrate having provided thereon a patterned adsorbed plating catalyst formed by the method of the invention.

### ADVANTAGEOUS EFFECT OF INVENTION

It is an object of the present invention to provide a method for adsorbing a catalyst, in which a plating catalyst can be adsorbed selectively or preferentially on a plating catalyst receiving region in a substrate made by forming a patterned hydrophobic plating catalyst receiving region on a hydrophobic surface, a substrate formed by using the method, and a method for preparing a substrate provided with a metal layer, which has excellent adhesiveness with the metal layer, and which is capable of forming a high-precision pattern.

It is another object of the invention to provide a plating solution which can be preferably used in the method for adsorbing a catalyst and the method for preparing a substrate provided with a metal layer of the invention.

### BEST MODE FOR CARRYING OUT THE INVENTION

Hereinafter, the present invention will be described in detail.

### [Method for Adsorbing Catalyst]

In the embodiment <1> of the invention, the method for adsorbing a catalyst is characterized in that it includes (1) a step of applying a photocurable composition which contains a compound having a functional group that is interactive with a plating catalyst or a precursor thereof and a polymerizable group, and forms a hydrophobic surface on a substrate (a first step), (2) a step of subjecting the substrate to pattern-wise exposure through a mask to cure the photocurable composition, thereby forming a surface-hydrophobic cured material layer on the exposure area (a second step), (3) a step of removing uncured materials of the photocurable composition with a developer to form a patterned surface-hydrophobic cured material layer (a third step), and (4) a step of bringing an aqueous plating catalyst solution containing a plating catalyst or a precursor thereof and an organic solvent into contact with the substrate having the patterned surface-hydrophobic cured material layer formed thereon (a fourth step).

In the method for adsorbing a catalyst in the embodiment <1> of the invention, as the indication of the plating catalyst adsorption in the patterned surface-hydrophobic cured material layer, when a palladium-containing test liquid is brought into contact with the substrate having the patterned surface-hydrophobic cured material layer formed thereon, A mg/m² and B mg/m², which respectively refer to a palladium adsorption amount in an area having the surface-hydrophobic cured material layer formed thereon and a palladium adsorption amount in an area not having the surface-hydrophobic cured material layer formed thereon, favorably satisfy the following relationship Formulae (A) and (B):

10 mg/m²≦A≦150 mg/m² Formula (A)

0 mg/m²≦B≦5 mg/m². Formula (B)

By this test, if the surface-hydrophobic cured material layer accomplishes the above-described adsorption amount, the invention can accomplish excellent effects even when using any one of various plating catalyst solutions to be described below.

Further, for the physical properties of the surface of the surface-hydrophobic cured material layer formed by curing the photocurable composition, the following Requirements 1 and 2 should be satisfied.

Requirement 1: saturated water absorption under the conditions of 25° C. and a relative humidity of 50% is from 0.01 to 5% by mass

Requirement 2: saturated water absorption under the conditions of 25° C. and a relative humidity of 95% is from 0.05 to 10% by mass

Further, regarding the penetration of the plating catalyst solution itself in the embodiment <3> of the invention, it is preferable that the plating catalyst solution penetrates selectively or preferentially into the surface-hydrophobic cured material layer, but the penetration is not limited as long as it is sufficient for adsorption of the plating catalyst or precursor thereof contained in the plating catalyst solution, and it is not necessary for the plating catalyst or precursor thereof to penetrate even into an area on which it is hard to work effectively for the plating to be continuously performed, that is, a deepest portion of the cured material layer. From such a viewpoint, taking note of the adsorption to the surface-hydrophobic cured material layer, the penetration performance of the plating catalyst solution can be evaluated by a plating catalyst solution containing palladium as a plating catalyst, that is, a palladium-containing test liquid. Specifically, the solvent of the palladium-containing test liquid may have absorption of from 3% to less than 50% relative to the weight of the surface-hydrophobic cured material layer, and further may have absorption of from 0.1% to less than 2.0% relative to the weight of an area not having the surface-hydrophobic cured material layer formed thereon.

Further, when taking note of the difference in the adsorptions between the areas having the surface-hydrophobic cured material layer of the plating catalyst solution formed and not formed, respectively, thereon, for the solvent of the plating catalyst solution containing palladium as a plating catalyst, C (% by mass) and D (% by mass), which refer to an absorption of palladium relative to the mass of the surface-hydrophobic cured material layer of the plating catalyst and an absorption of palladium relative to the mass of the area not having the surface-hydrophobic cured material layer of the plating catalyst formed thereon, respectively, preferably satisfy the following relationship formula (C):

0.002<(D/C)<0.67 Formula (C)

<(1) Step of Applying to a Substrate a Photocurable Composition which Contains a Compound Having a Functional Group that is Interactive with a Plating Catalyst or a Precursor Thereof and a Polymerizable Group, and Forms a Hydrophobic Surface>

The first step of method for adsorbing a catalyst of the invention is a step of applying a photocurable composition capable of forming a cured material layer which receives the plating catalyst or precursor thereof on a substrate.

The photocurable composition contains a compound having a functional group that is interactive with a plating catalyst or a precursor thereof and a polymerizable group. This functional group is a group capable of interacting with the plating catalyst or precursor thereof even after the step of photocuring.

Herein below, the invention will be described mainly on the basis of a case where a photosensitive resin composition is used as a photocurable composition.

—Photosensitive Resin Composition—

The photosensitive resin composition contains a compound which has a functional group that is interactive with a plating catalyst or a precursor thereof, which can produce a graft polymer by a surface graft polymerization method (hereinafter such a functional group is arbitrarily referred to as an “interactive group”) and a polymerizable group (hereinafter arbitrarily referred to as a specific polymerizable compound).

As the compound having an interactive group and a polymerizable group in the invention, a compound which has a polymerizable group and an interactive group, and also has low water absorbency and high hydrophobicity is preferably used.

From this viewpoint, the interactive group in the specific polymerizable compound is preferably a non-dissociative functional group, and the non-dissociative functional group means a functional group that does not generate a proton upon dissociation.

Such a functional group has a function to be interactive with the plating catalyst or a precursor thereof, but does not have high water absorbency or hydrophilicity such as those of a dissociative polar group (hydrophilic group), and accordingly, a resin coating film formed from a polymerizable compound having a functional group can form a hydrophobic coating film, into which an alkali developer or the like hardly penetrates.

The polymerizable group contained in the specific polymerizable compound is a functional group that bonds a compound having a polymerizable group and an interactive group to another compound having a polymerizable group and an interactive group, or bonds a compound having a polymerizable group and an interactive group to a substrate by application of energy. Specific examples of the polymerizable group include a vinyl group, a vinyloxy group, an allyl group, an acryloyl group, a methacryloyl group, an oxetane group, an epoxy group, an isocyanate group, a functional group containing active hydrogen, an active group in an azo compound, and the like.

Specifically, the interactive group contained in the specific polymerizable compound is preferably a group capable of interacting with a metal ion via a coordinate bond, and preferable examples thereof include a nitrogen-containing functional group, a sulfur-containing functional group, an oxygen-containing functional group, and the like. Specific examples thereof include nitrogen-containing functional groups such as an imide group, a pyridine group, a tertiary amino group, an ammonium group, a pyrrolidone group, an amidino group, a group having a triazine ring structure, a group having an isocyanuric structure, a nitro group, a nitroso group, an azo group, a diazo group, an azide group, a cyano group, a cyanate (R—O—CN) group, and the like, oxygen-containing functional groups such as an ether group, a carbonyl group, an ester group, a group having an N-oxide structure, a group having an S-oxide structure, a group having an N-hydroxy structure, and the like, sulfur-containing functional groups such as a thioether group, a thioxy group, a sulfoxide group, a sulfonic group, a sulfite group, a group having a sulfoximine structure, a group having a sulfoxonium salt structure, a group having a sulfonic acid ester structure, and the like, phosphorus-containing functional groups such as a phosphine group, and the like, groups containing a halogen atom such as chlorine, bromine, and the like, an unsaturated ethylene group, and the like. An imidazole group, a urea group or a thiourea group can also be used in the embodiment in which the group exhibits a non-dissociative function with respect to an adjacent atom or atomic group.

Among them, from the viewpoint of having high polarity and high adsorption capacity to a plating catalyst or the like, an ether group (more specifically, a group having a structure represented by —O—(CH₂)ₙ—O— (n is an integer of 1 to 5) or a cyano group is particularly preferred, and a cyano group is most preferred.

In general, as the polarity increases, the water absorption tends to increase. However, since cyano groups interact with each other so as to cancel the polarity thereof in the polymer layer, the film becomes dense and the polarity of the polymer layer as a whole decreases, thereby reducing the water absorbency. Further, in the below described method for preparing a substrate provided with a metal layer, by adsorbing the catalyst by a good solvent for the photosensitive resin composition when a plating catalyst or the like is adsorbed by forming a coating film, the cyano groups are solvated to cancel the interaction between the cyano groups, thereby enabling the cyano groups to interact with the plating catalyst or a precursor thereof by a coordination bond. For the above reasons, the cyano group-containing plating catalyst-receptive coating film is preferable in both of the contradicting properties, i.e., low moisture absorbency and favorable interaction with a plating catalyst are achieved.

Further, the interactive group in the invention is more preferably an alkylcyano group. This is because when for the aromatic cyano group, electrons are attracted to the aromatic ring to decrease the donating property of unpaired electrons that play an important role for the adsorbability to a plating catalyst or the like, but an alkylcyano group is not bonded to an aromatic ring, which thus is preferable in view of adsorbability to a plating catalyst or the like.

The polymerizable compound having an interactive group and a polymerizable group used in the photosensitive resin composition of the invention may be any one of a monomer, a macromonomer, oligomer, and a polymer. Among these, a macromonomer or a polymer having plural polymerizable groups is preferable from the viewpoint of a film forming property, and easy regulation of a film thickness or the physical properties as a cured material.

The specific polymerizable compound which can be used in the invention is preferably a polymer obtained from introducing an ethylene addition-polymerizable unsaturated group (polymerizable group) such as a vinyl group, an allyl group, a (meth)acryl group, and the like into a homopolymer or copolymer formed from a monomer having an interactive group. The polymer having a polymerizable group and an interactive group preferably has a polymerizable group at least at an end of the main chain or in a side chain, more preferably in a side chain.

Further, in the present specification, when both or either of “acryl and methacryl” is referred to, it may be expressed as “(meth)acryl” sometimes.

The monomer having an interactive group that is used for obtaining the compound having a polymerizable group and an interactive group may be any monomer having the aforementioned non-dissociative functional group, and specific examples thereof include those as described below.

These may be used singly or in combination of two or more kinds thereof.

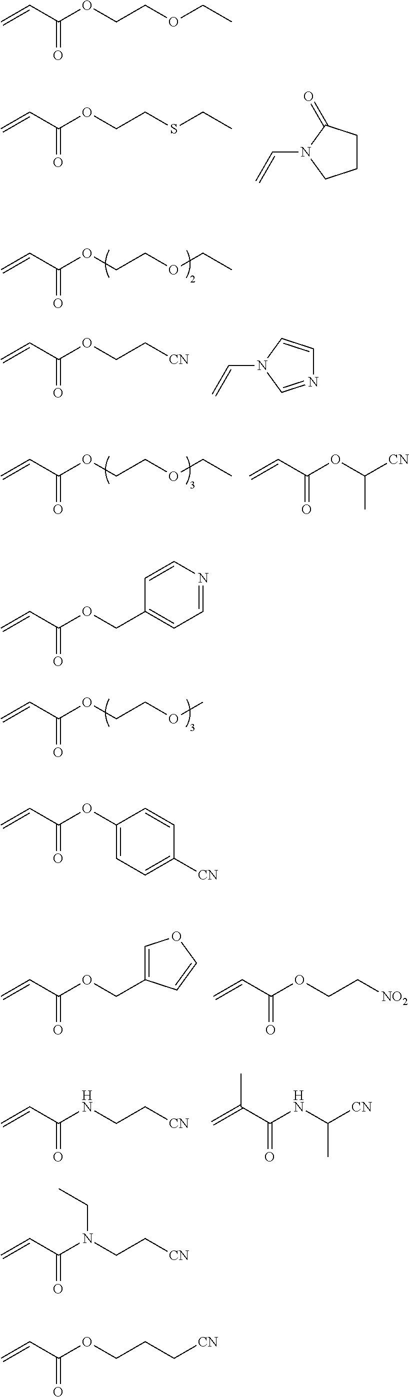

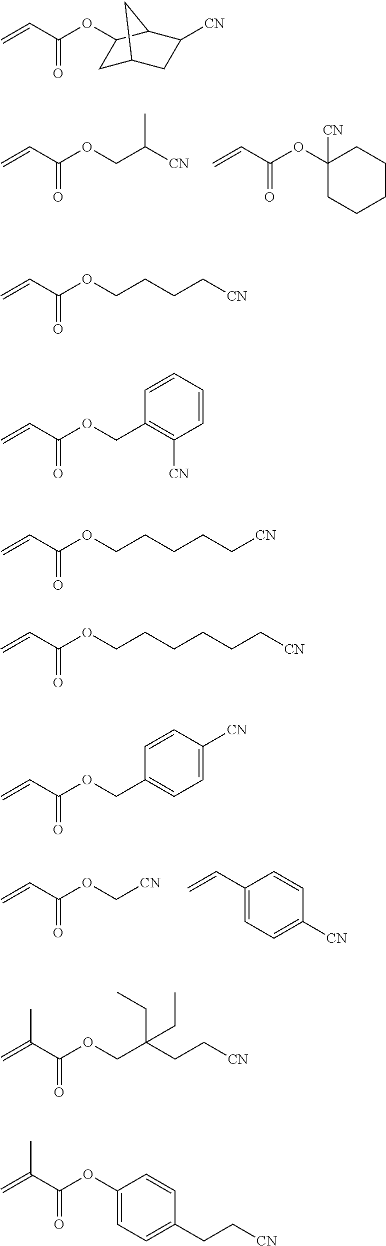

With respect to the compound having a polymerizable group and an interactive group (a macromonomer, an oligomer, a polymer, or the like), a unit derived from a monomer having an interactive group is preferably included in the polymerizable compound having a polymerizable group and an interactive group at an amount of 40 to 95% by mole, and more preferably 50 to 80% by mole, from the viewpoint of interaction forming properties with a plating catalyst or a precursor thereof.

Moreover, when obtaining the polymer having a polymerizable group and an interactive group, an additional monomer other than the above monomers having an interactive group may be used to reduce the water absorbency and improve the hydrophobicity. As such an additional monomer, general polymerizable monomers may be used. Examples of the monomer include a diene monomer, an acrylic monomer, and the like. Among these, -acrylic monomers having an unsubstituent alkyl moiety are preferable. Specifically, tertiary butyl acrylate, 2-ethylhexyl acrylate, butyl acrylate, cyclohexyl acrylate, benzyl methacrylate, or the like can be preferably used.

Such a polymer having the polymerizable group and the interacting group can be synthesized as described below.

Examples of the synthesis method include (i) a method of copolymerizing an interacting group-containing monomer and a polymerizable group-containing monomer, (ii) a method that includes copolymerizing an interacting group-containing monomer and a double bond precursor-containing monomer and then introducing a double bond by treatment with a base or the like, and (iii) a method of reacting an interacting group-containing polymer and a polymerizable group-containing monomer to introduce a double bond (to introduce a polymerizable group). In view of suitability for synthesis, preferred are the method (ii) that includes copolymerizing an interacting group-containing monomer and a double bond precursor-containing monomer and then introducing a double bond by treatment with a base or the like, and the method (iii) of reacting an interacting group-containing polymer and a polymerizable group-containing monomer to introduce a double bond.

As the interactive group-containing monomer used in the synthesis of the polymer having a polymerizable group and an interactive group, the same monomers as for the above-described interactive group-containing monomers can be used. The monomers may be used singly or in combination of two or more kinds thereof.

Examples of the polymerizable group-containing monomer to be copolymerized with the interacting group-containing monomer include allyl (meth)acrylate, 2-allyloxyethyl methacrylate, and the like.

Further, examples of the double bond precursor-containing monomer include 2-(3-chloro-1-oxopropoxy)ethyl methacrylate, 2-(3-bromo-1-oxopropoxy)ethyl methacrylate, and the like.

In addition, examples of the polymerizable group-containing monomer which is used to introduce an unsaturated group based on the reaction with a functional group in the interacting group-containing polymer, such as a carboxyl or amino group, or a salt thereof, a hydroxyl group, an epoxy group, and the like include (meth)acrylic acid, glycidyl (meth)acrylate, allyl glycidyl ether, 2-isocyanatoethyl (meth)acrylate, and the like.

Herein below, specific examples of the polymer having a polymerizable group and an interactive group which is preferably used in the invention are shown below, but the invention is not intended to be limited thereto.

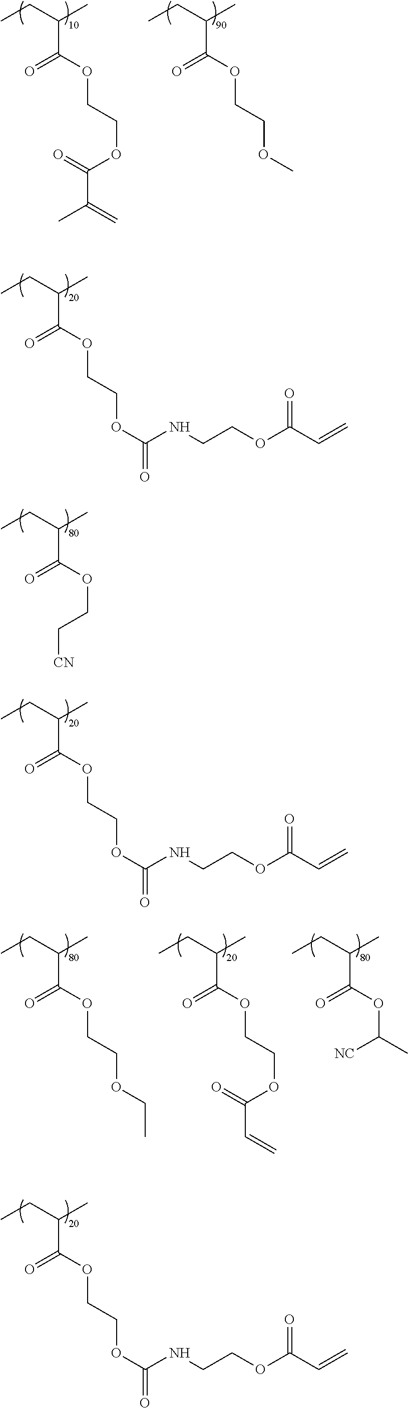

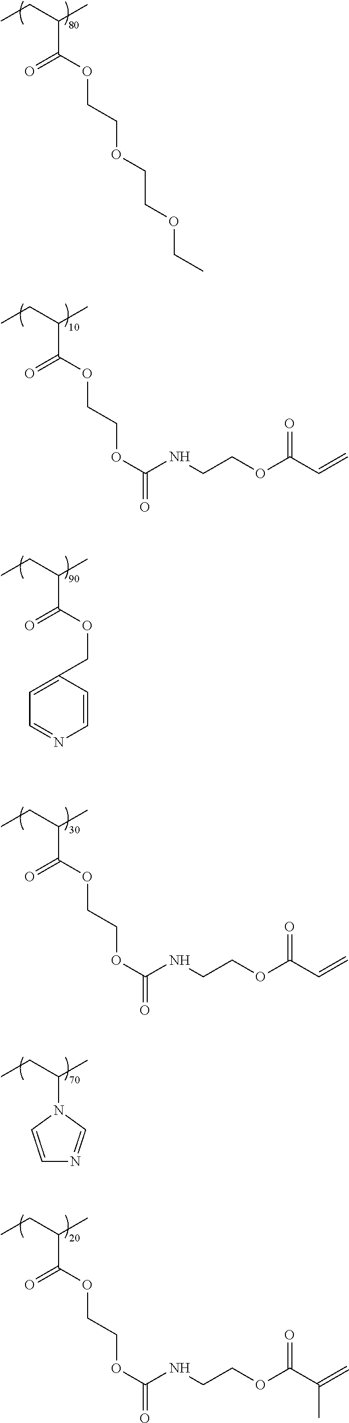

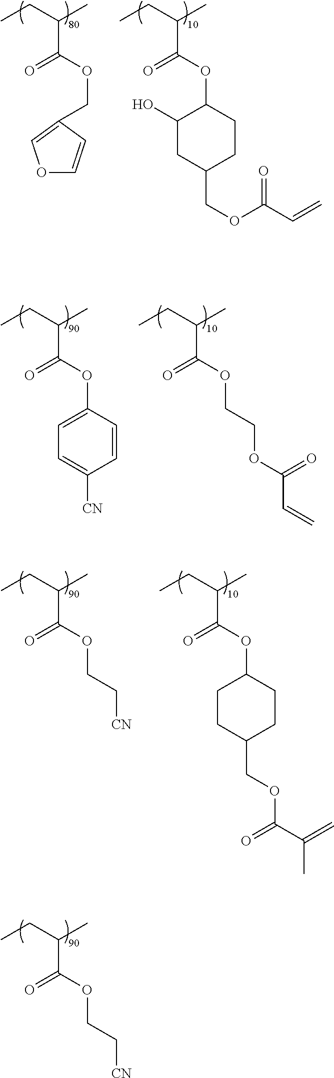

In the invention, for the polymer having a polymerizable group and an interactive group, the interactive group is preferably a cyano group-containing polymer (hereinafter referred to as a “cyano group-containing polymerizable polymer”).

The cyano group-containing polymerizable polymer in the invention is preferably a copolymer including, for example, a unit represented by the following Formula (1) and a unit represented by the following Formula (2).

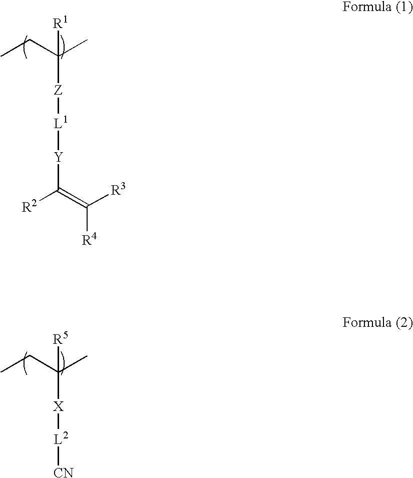

In Formula (1) and Formula (2), R¹ to R⁵ each independently represent a hydrogen atom, or a substituted or unsubstituted alkyl group, X, Y and Z each independently represent a single bond, a substituted or unsubstituted divalent organic group, ester group, amide group, or ether group, and L¹ and L² each independently represent a substituted or unsubstituted divalent organic group.

When R¹ to R⁵ are a substituted or unsubstituted alkyl group, examples of the unsubstituted alkyl group include a methyl group, an ethyl group, a propyl group, and a butyl group, and examples of the substituted alkyl group include a methyl group, an ethyl group, a propyl group, and a butyl group, which is substituted with a methoxy group, a hydroxyl group, a chlorine atom, a bromine atom, a fluorine atom, or the like.

Further, R¹ is preferably a hydrogen atom, a methyl group, or a methyl group substituted by a hydroxyl group or a bromine atom.

R² is preferably a hydrogen atom, a methyl group, or a methyl group substituted with a hydroxyl group or a bromine atom.

R³ is preferably a hydrogen atom.

R⁴ is preferably a hydrogen atom.

R⁵ is preferably a hydrogen atom, a methyl group, or a methyl group substituted with a hydroxyl group or a bromine atom.

When X, Y and Z are a substituted or unsubstituted divalent organic group, examples of the divalent organic group include a substituted or unsubstituted aliphatic hydrocarbon group, or a substituted or unsubstituted aromatic hydrocarbon group.

The substituted or unsubstituted aliphatic hydrocarbon group is preferably a methylene group, an ethylene group, a propylene group, a butylene group, or these groups substituted with a methoxy group, a hydroxyl group, a chlorine atom, a bromine atom, a fluorine atom or the like.

The substituted or unsubstituted aromatic hydrocarbon groups is preferably an unsubstituted phenyl group, or a phenyl group substituted with a methoxy group, a hydroxyl group, a chlorine atom, a bromine atom, a fluorine atom, or the like.

Among those, —(CH₂)ₙ— (n is an integer of 1 to 3) is preferred, and more preferred is —CH₂—.

L¹ is preferably a divalent organic group having an urethane bond or an urea bond, and more preferably a divalent organic group having an urethane bond. Among these, particularly preferred is one having a total number of carbon atoms of 1 to 9. Here, the total number of carbon atoms of L¹ means the total number of carbon atoms contained in the substituted or unsubstituted divalent organic group represented by L¹.

More specifically, the structure of L¹ is preferably a structure represented by the following Formula (1-1) or Formula (1-2).

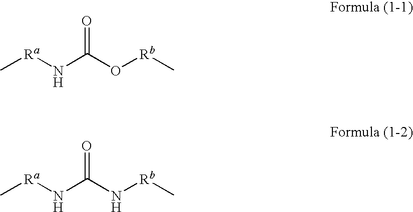

In Formula (1-1) and Formula (1-2), R^{a} and R^{b} each independently represent a divalent organic group formed from two or more atoms selected from the group consisting of a carbon atom, a hydrogen atom and an oxygen atom. Preferred examples thereof include a substituted or unsubstituted, methylene group, ethylene group, propylene group or butylene group, an ethylene oxide group, a diethylene oxide group, a triethylene oxide group, a tetraethylene oxide group, a dipropylene oxide group, a tripropylene oxide group, and a tetrapropylene oxide group.

Further, L² is preferably a linear, branched or cyclic alkylene group, an aromatic group, or a group formed from a combination of these groups. The group formed from a combination of an alkylene group and an aromatic group may further include an ether group, an ester group, an amide group, a urethane group or an urea group therebetween. Among those, L² is preferably a group having a total number of carbon atoms of 1 to 15, and particularly preferably a group having a total number of carbon atoms of 1 to 15 and having no substituent. Here, the total number of carbon atoms of L² means the total number of carbon atoms contained in the substituted or unsubstituted divalent organic group represented by L².

Specific examples of the substituted or unsubstituted divalent organic group represented by L² include a methylene group, an ethylene group, a propylene group, a butylene group, a phenylene group, these groups substituted with a methoxy group, a hydroxyl group, a chlorine atom, a bromine atom, a fluorine atom, or the like, and a group formed from a combination of these groups.

In the cyano group-containing polymerizable polymer in the invention, the unit represented by Formula (1) is preferably a unit represented by the following Formula (3).

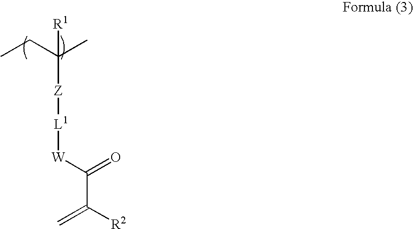

In Formula (3), R¹ and R² each independently represent a hydrogen atom, or a substituted or unsubstituted alkyl group; Z represents a single bond, a substituted or unsubstituted divalent organic group, ester group, amide group, or ether group; W represents an oxygen atom, or NR (wherein R represents a hydrogen atom or an alkyl group, preferably a hydrogen atom or an unsubstituted alkyl group having 1 to 5 carbon atoms); and L¹ represents a substituted or unsubstituted divalent organic group.

R¹ and R² in the Formula (3) have the same definitions as R¹ and R² in the Formula (1), and the same applies to the preferred examples thereof.

Z in the Formula (3) has the same definitions as Z in the Formula (1), and the same applies to the preferred examples thereof.

Also, L¹ in Formula (3) has the same definitions as L¹ in Formula (1), and the same applies to the preferred examples thereof.

In the cyano group-containing polymerizable polymer in the invention, the unit represented by Formula (3) is preferably a unit represented by the following Formula (4).

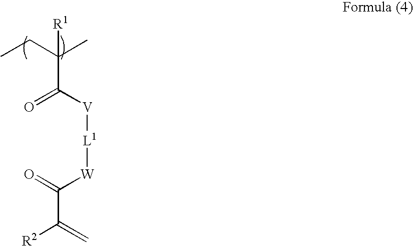

In Formula (4), R¹ and R² each independently represent a hydrogen atom, or a substituted or unsubstituted alkyl group; V and W each independently represent an oxygen atom, or NR (wherein R represents a hydrogen atom or an alkyl group, preferably a hydrogen atom or an unsubstituted alkyl group having 1 to 5 carbon atoms); and L¹ represents a substituted or unsubstituted divalent organic group.

R¹ and R² in Formula (4) have the same definitions as R¹ and R² in Formula (1), and the same applies to the preferred examples thereof.

L¹ in Formula (4) has the same definitions as L¹ in Formula (1), and the same applies to the preferred examples thereof.

In Formula (3) and Formula (4), W is preferably an oxygen atom.

Further, in Formula (3) and Formula (4), L¹ is preferably an unsubstituted alkylene group, or a divalent organic group having a urethane bond or a urea bond, more preferably a divalent organic group having a urethane bond. Among these, one having a total number of carbon atoms of 1 to 9 is particularly preferred.

In the cyano group-containing polymerizable polymer in the invention, the unit represented by Formula (2) is preferably a unit represented by the following Formula (5).

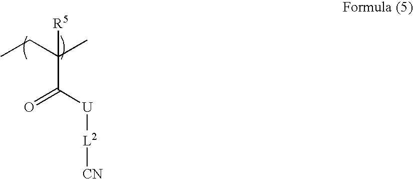

In Formula (5), R⁵ represents a hydrogen atom, or a substituted or unsubstituted alkyl group; U represents an oxygen atom, or NR′ (wherein R′ represents a hydrogen atom or an alkyl group, preferably a hydrogen atom or an unsubstituted alkyl group having 1 to 5 carbon atoms); and L² represents a substituted or unsubstituted divalent organic group.

R⁵ in Formula (5) has the same definitions as R¹ and R² in Formula (1), and is preferably a hydrogen atom.

Furthermore, L² in Formula (5) has the same definitions as L² in Formula (1), and is preferably a linear, branched or cyclic alkylene group, an aromatic group, or a group formed from a combination of these groups.

In particular, in Formula (5), the linkage site to the cyano group in L² is preferably a divalent organic group having a linear, branched or cyclic alkylene group, and more preferably such a divalent organic group having the total number of carbon atoms of 1 to 10.

In another preferred exemplary embodiment, the linkage site to the cyano group in L² in Formula (5) is preferably a divalent organic group having an aromatic group, and more preferably such a divalent organic group having the total number of carbon atoms of 6 to 15.

The cyano group-containing polymerizable polymer in the invention includes the units represented by Formula (1) to Formula (5), and is a polymer having a polymerizable group and a cyano group in a side chain thereof.

This cyano group-containing polymerizable polymer may be synthesized, for example, by the following method.

The type of polymerization reaction in the synthesis of the cyano group-containing polymerizable polymer in the invention includes radical polymerization, cationic polymerization and anionic polymerization. From the viewpoint of the reaction control, radical polymerization or cationic polymerization is preferably used.

The method of synthesizing the cyano group-containing polymerizable polymer in the invention is different between a case 1) where the polymerization mode of forming a polymer main chain is different from the polymerization mode of a polymerizable group introduced into a side chain, and a case 2) where the polymerization mode of forming a polymer main chain is the same as the polymerization mode of a polymerizable group introduced into a side chain.

1) A Case where the Polymerization Mode of Forming a Polymer Main Chain is Different from the Polymerization Mode of a Polymerizable Group Introduced into a Side Chain:

When the polymerization mode of forming a polymer main chain is different from the polymerization mode of a polymerizable group introduced into a side chain, there are an embodiment 1-1) where the formation of a polymer main chain is conducted by cation polymerization and the polymerization mode of a polymerizable group introduced into a side chain is radical polymerization, and an embodiment 1-2) where the formation of a polymer main chain is conducted by radical polymerization and the polymerization mode of a polymerizable group introduced into a side chain is cation polymerization.

### 1-1) An Embodiment where the Formation of a Polymer Main Chain is Conducted by Cation Polymerization and the Polymerization Mode of a Polymerizable Group Introduced into a Side Chain is Radical Polymerization

In the invention, examples of the monomers used in the embodiment where the formation of a polymer main chain is conducted by cation polymerization and the polymerization mode of a polymerizable group introduced into a side chain is radical polymerization include the following compounds.

Monomers Used for Formation of the Polymerizable Group-Containing Unit:

Examples of the monomers used for formation of the polymerizable group-containing unit in this embodiment include vinyl (meth)acrylate, allyl (meth)acrylate, 4-(meth)acryloyl butane vinyl ether, 2-(meth)acryloyl ethane vinyl ether, 3-(meth)acryloyl propane vinyl ether, (meth)acryloyloxy diethylene glycol vinyl ether, (meth)acryloyloxy triethylene glycol vinyl ether, (meth)acryloyl 1st terpineol, 1-(meth)acryloyloxy-2-methyl-2-propene, 1-(meth)acryloyloxy-3-methyl-3-butene, 3-methylene-2-(meth)acryloyloxy-norbornane, 4,4′-ethylidenediphenol di(meth)acrylate, methacrolein di(meth)acryloyl acetal, p-((meth)acryloylmethyl)styrene, allyl (meth)acrylate, vinyl 2-(bromomethyl)acrylate, allyl 2-(hydroxymethyl)acrylate, and the like.

Monomers Used for Formation of the Cyano Group-Containing Unit:

Examples of the monomers used for formation of the cyano group-containing unit in this embodiment include 2-cyanoethyl vinyl ether, cyanomethyl vinyl ether, 3-cyanopropyl vinyl ether, 4-cyanobutyl vinyl ether, 1-(p-cyanophenoxy)-2-vinyloxy-ethane, 1-(o-cyanophenoxy)-2-vinyloxy-ethane, 1-(m-cyanophenoxy)-2-vinyloxy-ethane, 1-(p-cyanophenoxy)-3-vinyloxy-propane, 1-(p-cyanophenoxy)-4-vinyloxy-butane, o-cyanobenzyl vinyl ether, m-cyanobenzyl vinyl ether, p-cyanobenzyl vinyl ether, allyl cyanide, allylcyanoacetic acid, the following compounds, and the like:

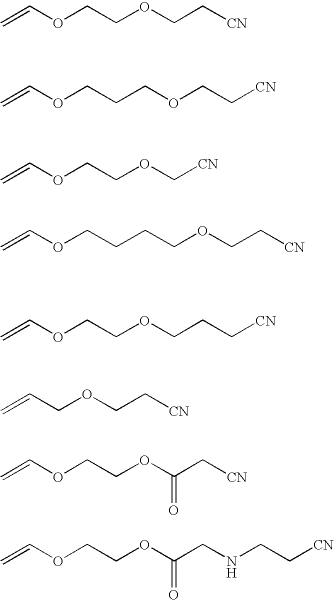

The polymerization method may be a method described in “Jikken Kagaku Koza, Kobunshi Kagaku (Experimental Chemical Course, Polymer Chemistry)”, chap. 2-4 (p. 74) and a general cation polymerization method described in “Kobunshi Gosei No Jikkenhouhou (Experimental Methods in Polymer Synthesis)” authored by Takayuki Otsu, chap. 7 (p. 195). In cation polymerization, a protonic acid, a metal halide, an organometal compound, an organic salt, a metal oxide, a solid acid and a halogen can be used as initiators, among which a metal halide and an organometallic compound are preferably used as an initiator having high activity and capable of synthesizing a high molecular weight polymers.

Specific examples thereof include boron trifluoride, boron trichloride, aluminum chloride, aluminum bromide, titanium tetrachloride, tin tetrachloride, tin bromide, phosphorus pentafluoride, antimony chloride, molybdenum chloride, tungsten chloride, iron chloride, dichloroethyl aluminum, chlorodiethyl aluminum, dichloromethyl aluminum, chlorodimethyl aluminum, trimethyl aluminum, trimethyl zinc, methyl Grignard, and the like.

### 1-2) An Embodiment where the Formation of a Polymer Main Chain is Conducted by Radical Polymerization and the Polymerization Mode of a Polymerizable Group Introduced into a Side Chain is Cation Polymerization

In the invention, the monomers used in the embodiment where the formation of a polymer main chain is conducted by radical polymerization and the polymerization mode of a polymerizable group introduced into a side chain is cation polymerization include the following compounds.

Monomers Used for Formation of the Polymerizable Group-Containing Unit

The same monomers as used in forming the polymerizable group-containing unit mentioned in the embodiment 1-1) can be used.

Monomers Used for Formation of the Cyano Group-Containing Unit

Examples of the monomers used for formation of the cyano group-containing unit in this embodiment include cyanomethyl (meth)acrylate, 2-cyanoethyl (meth)acrylate, 3-cyanopropyl (meth)acrylate, 2-cyanopropyl (meth)acrylate, 1-cyanoethyl (meth)acrylate, 4-cyanobutyl (meth)acrylate, 5-cyanopentyl (meth)acrylate, 6-cyanohexyl (meth)acrylate, 7-cyanoheptyl (meth)acrylate, 8-cyanooctyl (meth)acrylate, 2-cyanoethyl-(3-(bromomethyl)acrylate), 2-cyenoethyl-(3-(hydroxymethyl)acrylate), p-cyanophenyl (meth)acrylate, o-cyanophenyl (meth)acrylate, m-cyanophenyl (meth)acrylate, 5-(meth)acryloyl-2-carbonitrilo-norbornene, 6-(meth)acryloyl-2-carbonitrilo-norbornene, 1-cyano-1-(meth)acryloyl-cyclohexane, 1,1-dimethyl-1-cyano-methyl(meth)acrylate, 1-methyl-1-ethyl-1-cyano-methyl(meth)acrylate, o-cyanobenzyl (meth)acrylate, m-cyanobenzyl (meth)acrylate, p-cyanobenzyl (meth)acrylate, 1-cyanocycloheptyl acrylate, 2-cyanophenyl acrylate, 3-cyanophenyl acrylate, vinyl cyanoacetate, vinyl 1-cyano-1-cyclopropanecarboxylate, allyl cyanoacetate, allyl 1-cyano-1-cyclopropanecarboxylate, N,N-dicyanomethyl (meth)acrylamide, N-cyanophenyl (meth)acrylamide, allyl cyanomethyl ether, allyl-o-cyanoethyl ether, allyl-m-cyanobenzyl ether, allyl-p-cyanobenzyl ether, and the like.

Further, a monomer having a structure in which hydrogen atoms of the above-mentioned monomer is partially substituted with a hydroxyl group, an alkoxy group, halogen, a cyano group, or the like can also be used.

As the polymerization method, a method described in “Jikken Kagaku Koza, Kobunshi Kagaku (Experimental Chemical Course, Polymer Chemistry)”, chap. 2-2 (p. 34) or a general radical polymerization method described in “Kobunshi Gosei No Jikkenhouhou (Experimental Methods in Polymer Synthesis)” authored by Takayuki Otsu, chap. 5 (p. 125) can be used. Known radical polymerization initiators include a high-temperature initiator necessary for heating at 100° C. or higher, a usual initiator that initiates polymerization by heating at 40 to 100° C., a redox initiator that initiates polymerization at very low temperature, and the like, among which the usual initiator is preferable from the viewpoint of stability of the initiator and easy handling of polymerization reaction.

The usual initiator may be benzoyl peroxide, lauroyl peroxide, peroxodisulfate, azobisisobutyronitrile, and azobis-2,4-dimethylvaleronitrile.

2) A Case where the Polymerization Mode of Forming a Polymer Main Chain is the Same as the Polymerization Mode of a Polymerizable Group Introduced into a Side Chain:

When the polymerization mode of forming a polymer main chain is the same as the polymerization mode of a polymerizable group introduced into a side chain, there are an embodiment 2-1) wherein both the polymerization modes are cation polymerization and an embodiment 2-2) wherein both the polymerization modes are radical polymerization.

### 2-1) An Embodiment Wherein Both the Polymerization Modes are Cation Polymerization

In the embodiment where both the polymerization modes are cation polymerization, the cyano group-containing monomer may be the same as the monomer used in forming the cyano group-containing unit mentioned in the embodiment 1-1) above.

From the viewpoint of preventing gelation during polymerization, it is preferable to use a method wherein the cyano group-containing polymer is previously synthesized and then reacted with a compound having a polymerizable group capable of cationic polymerization (hereinafter referred to sometimes as “reactive compound”) thereby introducing the polymerizable group capable of cationic polymerization into the side chain.

Furthermore, to react with the reactive compound, the cyano group-containing polymer preferably has a reactive group as shown below.

Also, the cyano group-containing polymer and the reactive compound are preferably selected appropriately so as to have the following combination of functional groups.

Specific examples of the combination include:

(Reactive group of the polymer, Functional group of the reactive compound)=(carboxyl group, carboxyl group), (carboxyl group, epoxy group), (carboxyl group, isocyanate group), (carboxyl group, benzyl halide), (hydroxyl group, carboxyl group), (hydroxyl group, epoxy group), (hydroxyl group, isocyanato group), (hydroxyl group, benzyl halide) (isocyanato group, hydroxyl group), (isocyanato group, carboxyl group), and the like.

Here, specific examples of the reactive compound include the compounds as shown below:

That is, examples include allyl alcohol, 4-hydroxybutane vinyl ether, 2-hydroxyethane vinyl ether, 3-hydroxypropane vinyl ether, hydroxy triethylene glycol vinyl ether, 1st terpineol, 2-methyl-2-propenol, 3-methyl-3-butenol, 3-methylene-2-hydroxy-norbornane, and p-(chloromethyl) styrene.

### 2-2) An Embodiment Wherein Both the Polymerization Modes are Radical Polymerization

In the embodiment wherein both the polymerization modes are radial polymerization, the synthesis method may be a method i) wherein a cyano group-containing monomer is copolymerized with a monomer having a polymerizable group, a method ii) wherein a cyano group-containing monomer is copolymerized with a monomer having a double bond precursor and then treated with a base or the like to introduce a double bond into the product, and a method iii) wherein a cyano group-containing polymer is reacted with a polymerizable group-containing monomer, thereby introducing a double bond (introducing the polymerizable group) into the polymer. Among these methods, the method ii) wherein a cyano group-containing monomer is copolymerized with a monomer having a double bond precursor and then treated with a base or the like to introduce a double bond into the product and a method iii) wherein a cyano group-containing polymer is reacted with a polymerizable group-containing monomer, thereby introducing the polymerizable group into the polymer are preferable from the viewpoint of synthesis adaptability.

Examples of the polymerizable group-containing monomer used in the synthesis method i) include allyl (meth)acrylate, the following compounds, and the like.

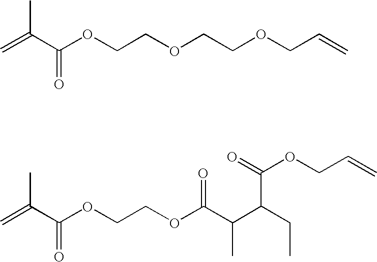

Examples of the monomer having a double bond precursor used in the method ii) include the compounds represented by the following Formula (a), and the like.

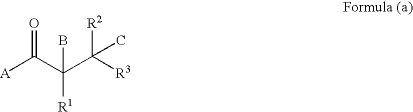

In Formula (a), A represents an organic atomic group having a polymerizable group, R¹ to R³ each independently represent a hydrogen atom or a monovalent organic group, B and C each represent a leaving group that is removed by a leaving reaction. The leaving reaction here refers to a reaction in which C is abstracted from the above structure by the action of a base and B also leaves from the above structure. It is preferable that B leave as an anion and C leave as a cation.

Specific examples of the compound represented by Formula (a) include the following compounds.

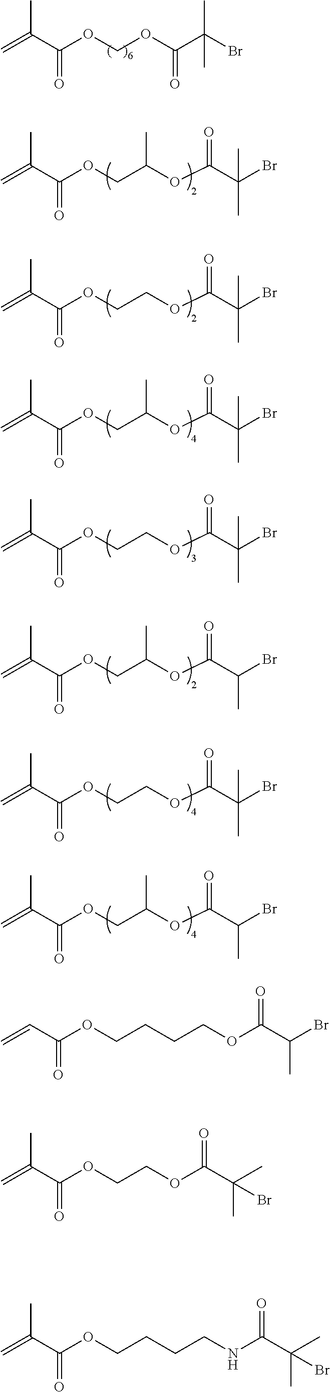

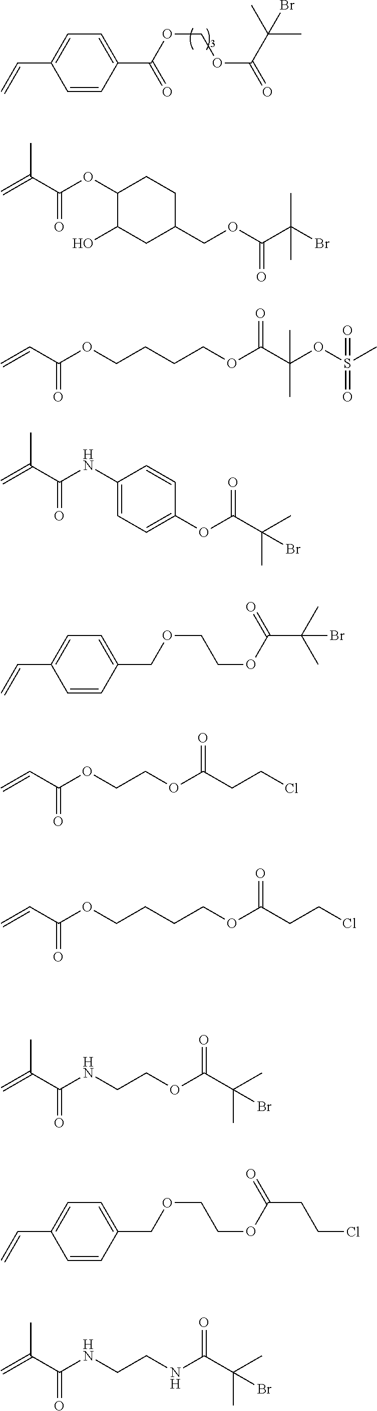

For conversion of the double bond precursor into a double bond in the synthesis method ii), a method as shown below wherein the leaving groups represented by B and C are removed by the leaving reaction; that is, the reaction wherein C is abstracted by the action of a base and B leaves is used.

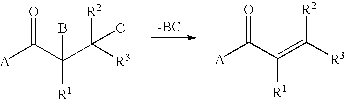

The base used in the leaving reaction is preferably a hydride, hydroxide, or carbonate of an alkali metal, an organic amine compound, or a metal alkoxide compound. Preferable examples of the hydride, hydroxide, and carbonate of an alkali metal include sodium hydride, calcium hydride, potassium hydride, sodium hydroxide, potassium hydroxide, calcium hydroxide, potassium carbonate, sodium carbonate, potassium hydrogen carbonate, sodium hydrogen carbonate, and the like. Examples of the organic amine compound include trimethylamine, triethylamine, diethylmethylamine, tributylamine, triisobutylamine, trihexylamine, trioctylamine, N,N-dimethylcyclohexylamine, N,N-diethylcyclohexylamine, N-methyldicyclohexylamine, N-ethyldicyclohexylamine, pyrrolidine, 1-methylpyrrolidine, 2,5-dimethylpyrrolidine, piperidine, 1-methylpiperidine, 2,2,6,6-tetramethylpiperidine, piperazine, 1,4-dimethylpiperazine, quinuclidine, 1,4-diazabicyclo[2,2,2]-octane, hexamethylenetetramine, morpholine, 4-methylmorpholine, pyridine, picoline, 4-dimethylaminopyridine, lutidine, 1,8-diazabicyclo[5,4,0]-7-undecene (DBU), N,N′-dicyclohexylcarbodiimide (DCC), diisopropylethylamine, a Schiff base, and the like. Preferable examples of the metal alkoxide compound include sodium methoxide, sodium ethoxide, potassium t-butoxide, and the like. These base groups may be used singly or as a mixture of two or more kinds thereof.

Further, in the leaving reaction, examples of the solvent used for applying (adding) the base include ethylene dichloride, cyclohexanone, methyl ethyl ketone, acetone, methanol, ethanol, propanol, butanol, ethylene glycol monomethyl ether, ethylene glycol monoethyl ether, 2-methoxyethyl acetate, 1-methoxy-2-propanol, 1-methoxy-2-propyl acetate, N,N-dimethylformamide, N,N-dimethylacetamide, dimethylsulfoxide, toluene, ethyl acetate, methyl lactate, ethyl lactate, water, and the like. These solvents may be used singly or as a mixture of two or more kinds thereof.

The amount of the base to be used may be no more than or no less than the equivalent of the specific functional groups (leaving groups represented by B and C) in the compound. Further, when an excess of the base is used, it is also a preferable mode to add an acid or the like after the leaving reaction so as to remove the residual base.

The cyano group-containing polymer used in the synthesis method iii) can be synthesized by performing radical polymerization of a monomer used to form a cyano group-containing unit as mentioned in the embodiment 1-2) and a monomer having a reactive group for introduction of a double bond.

Example of the monomer having a reactive group for introduction of a double bond include monomers having, as a reactive group, a carboxyl group, a hydroxyl group, an epoxy group, or an isocyanate group.

Examples of the carboxyl group-containing monomer include (meth)acrylic acid, itaconic acid, vinyl benzoate, ARONIX M-5300, M-5400, and M-5600, manufactured by TOAGOSEI CO., LTD., ACRYLESTER PA and HH, manufactured by MITSUBISHI RAYON CO., LTD., LIGHT ACRYLATE HOA-HH, manufactured by KYOEISHA CHEMICAL CO., LTD., NK ESTER SA and A-SA, manufactured by NAKAMURA CHEMICAL CORPORATION, and the like.

Examples of the hydroxyl group-containing monomer include 2-hydroxyethyl(meth)acrylate, 4-hydroxybutyl(meth)acrylate, 2-hydroxypropyl(meth)acrylate, 2-hydroxybutyl(meth)acrylate, 1-(meth)acryloyl-3-hydroxy-adamantane, hydroxymethyl(meth)acrylamide, (2-hydroxyethyl)-(meth)acrylate, 3-chloro-2-hydroxypropyl(meth)acrylate, 3,5-dihydroxypentyl(meth)acrylate, 1-hydroxymethyl-4-(meth)acryloylmethyl-cyclohexane, 2-hydroxy-3-phenoxypropyl(meth)acrylate, 1-methyl-2-acryloyloxypropyl phthalic acid, 2-acryloyloxyethyl-2-hydroxyethyl phthalic acid, 1-methyl-2-acryloyloxyethyl-2-hydroxypropyl phthalic acid, 2-acryloyloxyethyl-2-hydroxy-3-chloropropyl phthalic acid, ARONIX M-554, M-154, M-555, M-155 and M-158, manufactured by TOAGOSEI CO., LTD., BLEMMER PE-200, PE-350, PP-500, PP-800, PP-1000, 70 PEP-350 B, 55 PET800, manufactured by NOF CORPORATION, and a lactone-modified acrylate having the following structure.

CH₂═CRCOOCH₂CH₂[OC(═O)C₅H₁₀]ₙOH

(R═H or Me, n=1 to 5)

Examples of the epoxy group-containing monomer include glycidyl(meth)acrylate, CYCLOMER A and M, manufactured by DAICEL CHEMICAL INDUSTRIES, LTD. and the like.

Examples of the isocyanate group-containing monomer include KARENZ AOI and MOI, manufactured by SHOWA DENKO K.K.

In addition, the cyano group-containing polymer used in the synthesis method iii) may further include another third copolymerization component.

In the synthesis method iii), the type of the polymerizable group-containing monomer to be reacted with the cyano group-containing polymer varies according to the type of the reactive group in the cyano group-containing polymer. The following combinations of the functional group-containing monomers can be used.

That is, the combinations thereof include:

(Reactive group of the polymer, Functional group of the monomer)=(carboxyl group, carboxyl group), (carboxyl group, epoxy group), (carboxyl group, isocyanate group), (carboxyl group, benzyl halide), (hydroxyl group, carboxyl group), (hydroxyl group, epoxy group), (hydroxyl group, isocyanato group), (hydroxyl group, benzyl halide) (isocyanate group, hydroxyl group), (isocyanato group, carboxyl group), (epoxy group, carboxyl group), and the like.

Specifically, the following monomers can be used.

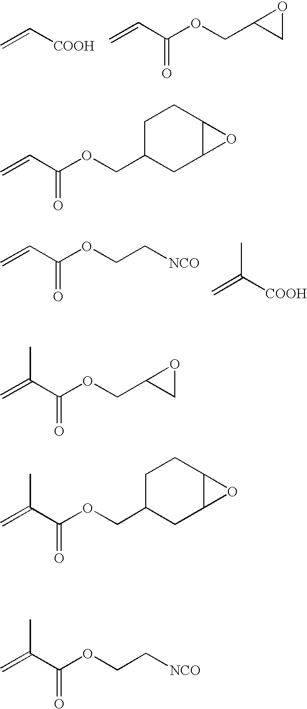

With respect to the cyano group-containing polymerizable polymer in the invention, if L¹ in the formula (1), the formula (3), or the formula (4) is a structure that is a divalent organic group having an urethane bond, it is preferred that the synthesis is conducted by the following synthesis method (hereinafter referred to as Synthesis Method A).

That is, Synthesis Method A in the invention is characterized in that both a polymer containing a hydroxyl group in the side chain and a compound having an isocyanate group and a polymerizable group are used, at least in a solvent, to add the isocyanate group to the hydroxyl group, thereby forming a urethane bond in L¹.

Here, as the polymer containing a hydroxyl group in the side chain used in Synthesis Method A, the copolymers of the monomers used so as to form cyano group-containing units as mentioned in the embodiment 1-2) above and the hydroxyl group-containing (meth)acrylate as described below are preferable. Examples of the hydroxyl group-containing (meth)acrylate include those (meth)acrylates as exemplified above as the hydroxyl group-containing monomers.

Further, the polymer containing a hydroxyl group in the side chain used in Synthesis Method A may further contain a third copolymerization component.

From the viewpoint of the synthesis of a high-molecular polymer among the above-described polymers containing a hydroxyl group in the side chain, a polymer synthesized by using a raw material obtained by removing bifunctional acrylates produced as a by-product upon synthesis of the hydroxyl group-containing (meth)acrylate may be used as the raw material. As the method for purification the hydroxyl group-containing (meth)acrylate, distillation or column purification is preferred. The product synthesized using the hydroxyl group-containing (meth)acrylate obtained by sequentially conducting the following steps (I) to (IV) is more preferred.

(I) a step of dissolving, in water, a mixture of hydroxyl group-containing (meth)acrylate and a bifunctional acrylate that is produced as a by-product upon synthesis of the hydroxyl group-containing (meth)acrylate.

(II) a step of adding a first organic solvent that separates from water to the obtained aqueous solution, and then separating the layer including the first organic solvent and the bifunctional acrylate from the aqueous layer.

(III) a step of dissolving, in the aqueous layer, a compound having higher water solubility than that of the hydroxyl group-containing (meth)acrylate.

(IV) a step of adding a second organic solvent to the aqueous layer to extract the hydroxyl group-containing (meth)acrylate, and then concentrating the same.

The mixture used in the (I) step contains the hydroxyl group-containing (meth)acrylate, and bifunctional acrylate that is an impurity produced as a by-product upon synthesis of the hydroxyl group-containing (meth)acrylate, which corresponds to a general commercially-available product of the hydroxyl group-containing (meth)acrylate.

In the (I) step, this commercially-available product (mixture) is dissolved in water to obtain an aqueous solution.

In the (II) step, a first organic solvent that separates from water is added to the aqueous solution obtained in the (I) step. Examples of the first organic solvent used herein include ethyl acetate, diethyl ether, benzene, toluene, and the like.

Thereafter, the layer (oily layer) including the first organic solvent and the bifunctional acrylate is separated from the aqueous solution (aqueous layer).

In the (III) step, a compound having higher water solubility than that of the hydroxyl group-containing (meth)acrylate is dissolved in the aqueous layer separated from the oily layer in the (II) step.

Examples of the compound having higher water solubility than that of the hydroxyl group-containing (meth)acrylate used herein include inorganic salts including alkali metal salts such as sodium chloride, potassium chloride, and the like, alkali earth metal salts such as magnesium sulfate, calcium sulfate, and the like, etc.

In the (IV) step, a second organic solvent is added to the aqueous layer to extract the hydroxyl group-containing (meth)acrylate, and then concentrating the same.

Examples of the second organic solvent used herein include ethyl acetate, diethyl ether, benzene, toluene, and the like. This second organic solvent may be the same as or different from the above-described first organic solvent.

For concentration in the (IV) step, drying over anhydrous magnesium sulfate, distillation under reduced pressure, or the like is used.

An isolated product containing the hydroxyl group-containing (meth)acrylate obtained by sequentially performing the (I) to (IV) steps preferably contains the bifunctional acrylate in the range of 0.1% by mass or less, relative to the total mass of the isolated product. That is, by performing the (I) to (IV) steps, the bifunctional acrylate which is an impurity is removed from the mixture, whereby the hydroxyl group-containing (meth)acrylate is purified.

A more preferable range of the content of the bifunctional acrylate is 0.05% by mass or less relative to the total mass of the isolated product, and a less content of the bifunctional acrylate is more preferable.

By using thus purified hydroxyl group-containing (meth)acrylate, the bifunctional acrylate which is an impurity hardly affects the polymerization reaction, and as a result, a nitrile group-containing polymerizable polymer having a weight average molecular weight of 20000 or more can be synthesized.

As the hydroxy group-containing (meth)acrylate used in the (I) step, those as exemplified as the hydroxyl group-containing (meth)acrylate used upon synthesis of the polymer containing a hydroxyl group in the side chain used in the above-described Synthesis Method A can be used. Among those, from the viewpoint of the reactivity to the isocyanate, a monomer having a primary hydroxyl group is preferable, and from the viewpoint of increasing the ratio of the polymerizable groups per unit weight of the polymer, a hydroxy group-containing (meth)acrylate having a molecular weight of 100 to 250 is preferable.

Further, examples of the compound containing an isocyanate group and a polymerizable group used in the Synthesis Method A include 2-acryloyloxy ethyl isocyanate (Karenz AOI, manufactured by Showa Denko K.K.), 2-methacryl oxy isocyanate (Karenz MOI, manufactured by Showa Denko K.K.), and the like.

Further, as the solvent used in the Synthesis Method A, those having an SP value (determined by an OKITSU method) of 20 to 23 MPa^{1/2} are preferable, and specific examples thereof include ethylene glycol diacetate, diethylene glycol diacetate, propylene glycol diacetate, methyl acetoacetate, ethyl acetoacetate, 1,2,3-triacetoxy-propane, cyclohexanone, 2-(1-cyclohexenyl)cyclohexanone, propionitrile, N-methylpyrrolidone, dimethylacetamide, acetylacetone, acetophenone, triacetin, 1,4-dioxane, dimethyl carbonate, and the like.

Among these, from the viewpoint of synthesis of a high-molecular product, ester-based solvents are more preferable, and particularly, diacetate-based solvents such as ethylene glycol diacetate, diethylene glycol diacetate, and the like, and dimethyl carbonate are more preferable.

Here, the SP value of the solvent in the invention is determined by an OKITSU method (Toshinao Okitsu, “Journal of the Adhesion Society of Japan”, 29 (3) (1993)). Specifically, the SP value is calculated by the following equation. Furthermore, ΔF is a value described in the literature.

SP Value(δ)=ΣΔF(Molar Attraction Constants)/V(Molar Volume)

The ratio of the cyano group-containing polymerizable polymer of the invention synthesized as described above preferably has a ratio of the polymerizable group-containing units and the cyano group-containing units, relative to the total amount of the copolymerization component, in the following range.

That is, the polymerizable group-containing units are contained preferably in an amount of 5 to 50% by mole, and more preferably 5 to 40% by mole, relative to the total amount of the copolymerization components. When the amount is less than 5% by mole, the reactivity (curability, polymerizability) is deteriorated, while when the amount is more than 50% by mole, gelation easily occurs upon synthesis to make the synthesis difficult.

Further, the cyano group-containing units are contained preferably at an amount of 5 to 95% by mole, and more preferably 10 to 95% by mole, relative to the total amount of the copolymerization components, from the viewpoint of the adsorptivity to the plating catalyst.

Furthermore, the cyano group-containing polymerizable polymer in the invention may contain other units, in addition to the cyano group-containing units and the polymerizable group-containing units. The monomers used to form other units may be any monomers as long as the effect of the invention is not impaired.

Specific examples of the monomer used to form other units include the monomers capable of forming main-chain skeletons such as an acryl resin skeleton, a styrene resin skeleton, a phenol resin (phenol/formaldehyde resin) skeleton, a melamine resin (melamine/formaldehyde polycondensate) skeleton, an urea resin (urea/formaldehyde polycondensate) skeleton, a polyester resin skeleton, a polyurethane skeleton, a polyimide skeleton, a polyolefin skeleton, a polycycloolefin skeleton, a polystyrene skeleton, polyacrylic skeleton, an ABS resin (acrylonitrile/butadiene/styrene polymer) skeleton, a polyamide skeleton, a polyacetal skeleton, a polycarbonate skeleton, a polyphenylene ether skeleton, a polyphenylene sulfide skeleton, a polysulfone skeleton, a polyether sulfone skeleton, a polyaryl skeleton, a polyether ether ketone skeleton, a polyamide imide skeleton, and the like.

Further, these main chain skeletons may be the main chain skeletons of the cyano group-containing units or the polymerizable group-containing units.

However, when a polymerizable group is introduced by a reaction with a polymer as described above, a small amount of the reactive sites may remain if 100% introduction is difficult, and thus such remaining reactive sites may form a third unit.

Specifically, when the polymer main chain is formed by radical polymerization, it is possible to use unsubstituted (meth)acrylic acid esters such as ethyl (meth)acrylate, butyl (meth)acrylate, hexyl (meth)acrylate, 2-ethylhexyl (meth)acrylate, cyclohexyl (meth)acrylate, benzyl (meth)acrylate, stearyl (meth)acrylate, and the like; halogen-substituted (meth)acrylic acid esters such as 2,2,2-trifluoroethyl (meth)acrylate, 3,3,3-trifluoropropyl (meth)acrylate, 2-chloroethyl (meth)acrylate, and the like; ammonium group-substituted (meth)acrylic acid esters such as 2-(meth)acryloyloxyethyl trimethyl ammonium chloride; (meth)acrylamides such as butyl (meth)acrylamide, isopropyl (meth)acrylamide, octyl (meth)acrylamide, dimethyl (meth)acrylamide, and the like; styrenes such as styrene, vinylbenzoic acid, p-vinylbenzylammonium chloride, and the like; or vinyl compounds such as N-vinylcarbazole, vinyl acetate, N-vinylacetamide, N-vinylcaprolactam, and the like. Further, dimethylaminoethyl (meth)acrylate, diethylaminoethyl (meth)acrylate, 2-ethylthio-ethyl (meth)acrylate, (meth)acrylic acid, 2-hydroxyethyl (meth)acrylate, or the like may be used.

Macromonomers obtained by using the monomers described above may also be used.

When the polymer main chain is formed by cation polymerization, it is possible to employ vinyl ethers such as ethyl vinyl ether, butyl vinyl ether, isobutyl vinyl ether, cyclohexyl vinyl ether, ethylene glycol vinyl ether, di(ethylene glycol) vinyl ether, 1,4-butanediol vinyl ether, 2-chloroethyl vinyl ether, 2-ethylhexyl vinyl ether, vinyl acetate, 2-vinyloxytetrahydropyran, vinyl benzoate, vinyl butyrate, and the like; styrenes such as styrene, p-chlorostyrene, p-methoxystyrene, and the like; and ethylene-terminated compounds such as allyl alcohol, 4-hydroxy-1-butene and the like.

The weight-average molecular weight of the cyano group-containing polymerizable polymer in the invention is preferable from 1000 to 700000, and more preferably from 2000 to 200000. Particularly, from the viewpoint of polymerization sensitivity, the weight-average molecular weight of the cyano group-containing polymerizable polymer in the invention is preferable 20000 or more.

Further, regarding the polymerization degree of the cyano group-containing polymerizable polymer of the invention, those having a 10-mer or more are preferably used, and those having a 20-mer or more are more preferably used. Further, those having a 7000-mer or less are preferable, those having a 3000-mer or less are more preferable, those having a 2000-mer or less are further preferable, and those having a 1000-mer or less are particularly preferable.

The preferred ranges of the molecular weight and the polymerization degrees as described herein are also very desirable ranges with respect to the polymer having a polymerizable group and an interactive group, in addition to the cyano group-containing polymerizable polymer used in the invention.

Specific examples of the cyano group-containing polymerizable polymer in the invention include, but are not limited to, the followings.

Further, the weight-average molecular weights of these specific examples are all in the range of 3000 to 100000.

### Polymer Obtained by Embodiment 1-1

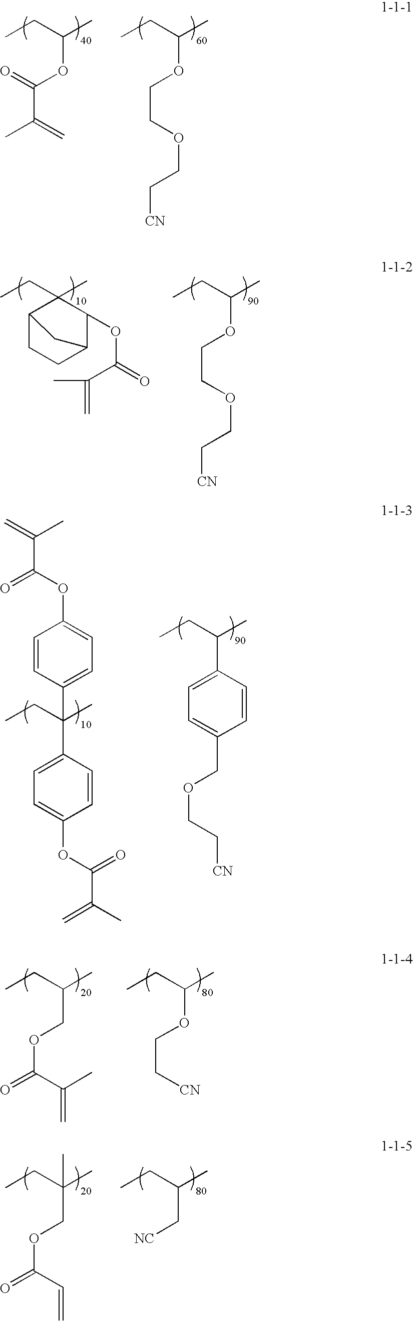

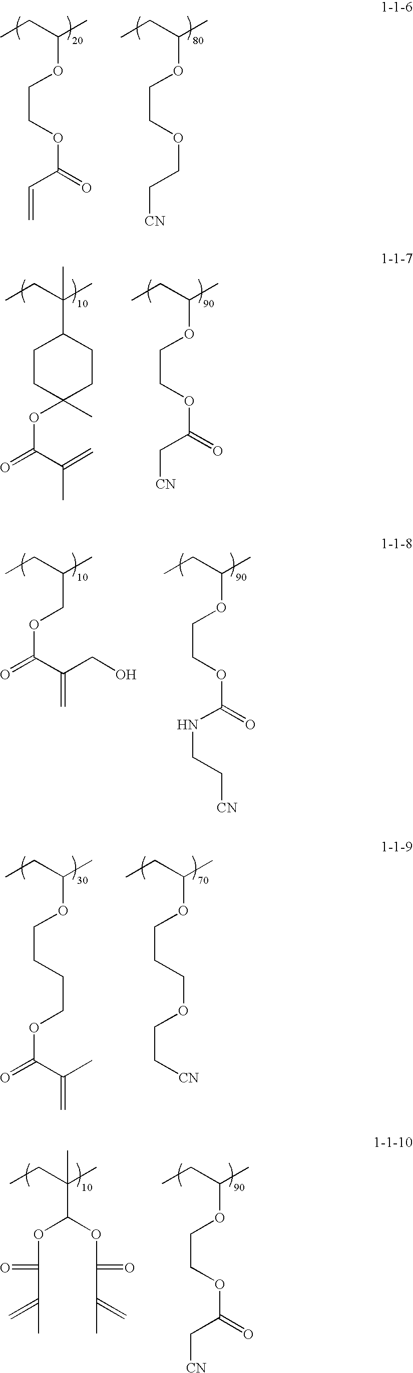

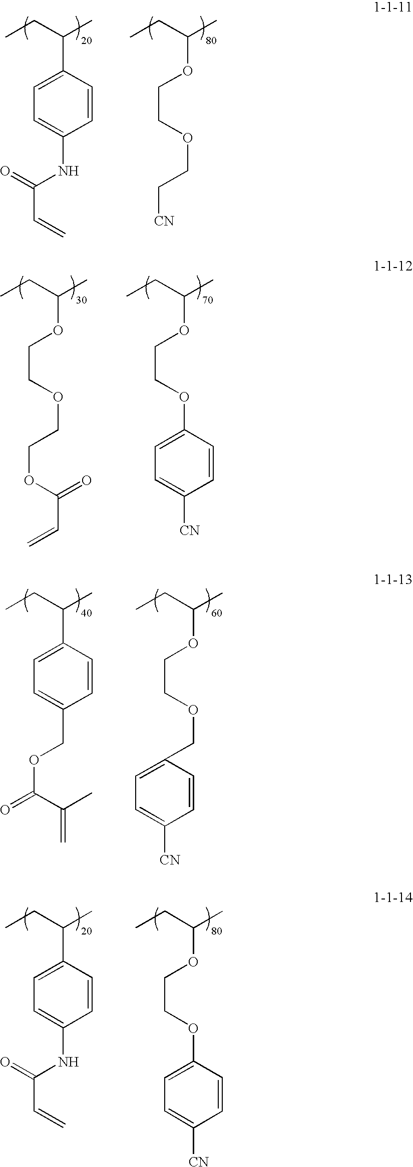

### Polymer Obtained by Embodiment in 1-2

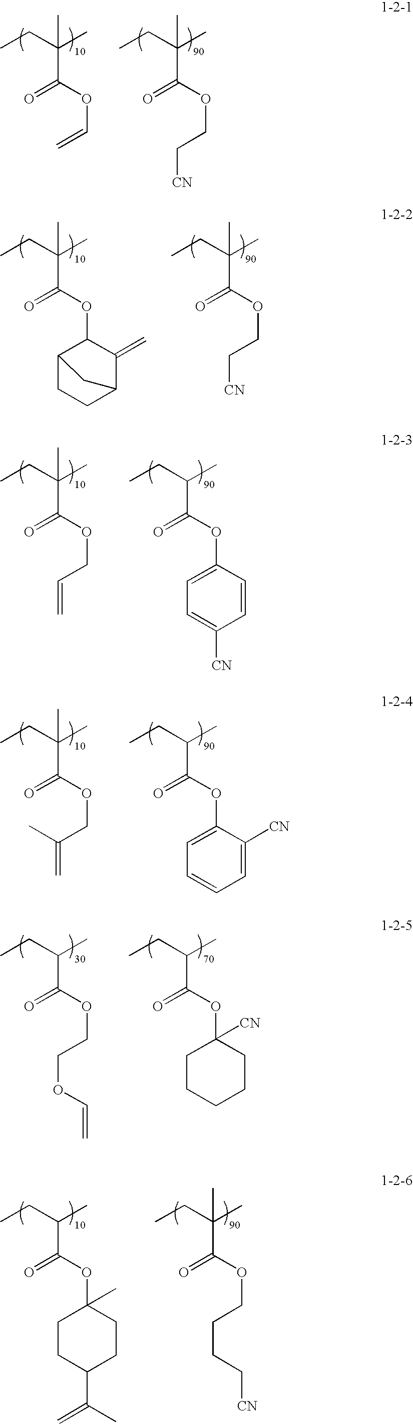

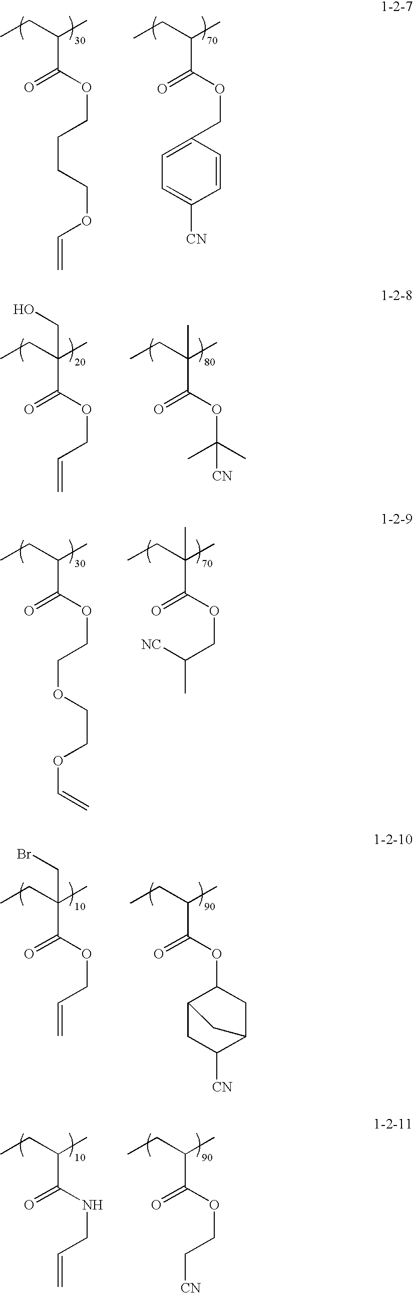

### Polymer Obtained by Embodiment 2-1

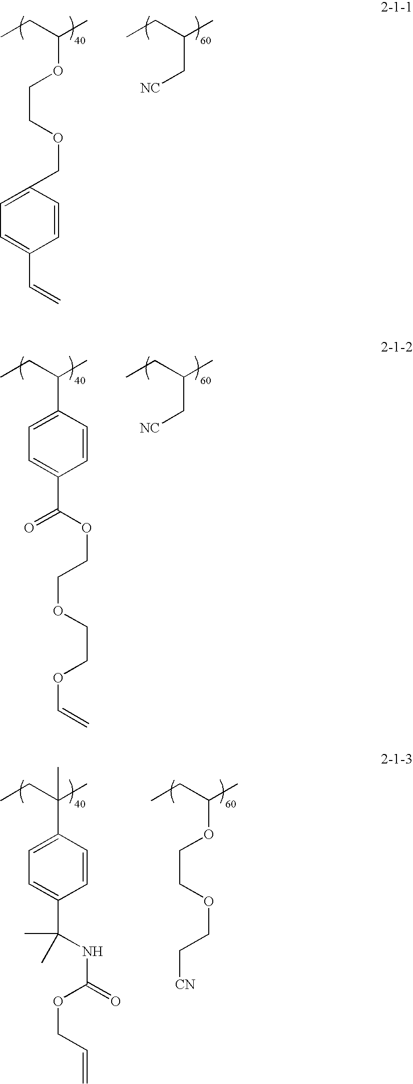

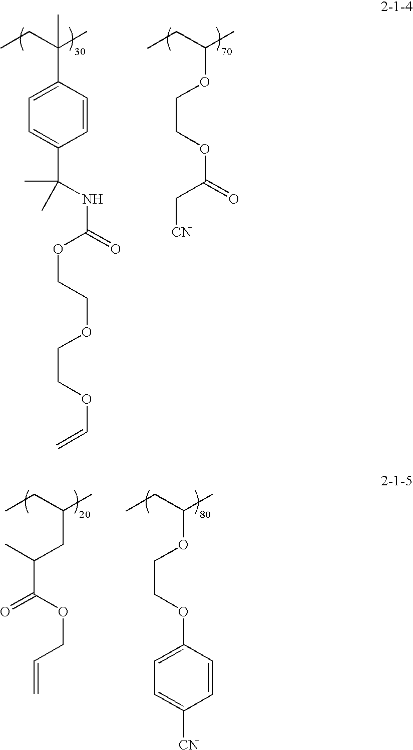

### Polymer Obtained by Embodiment 2-2

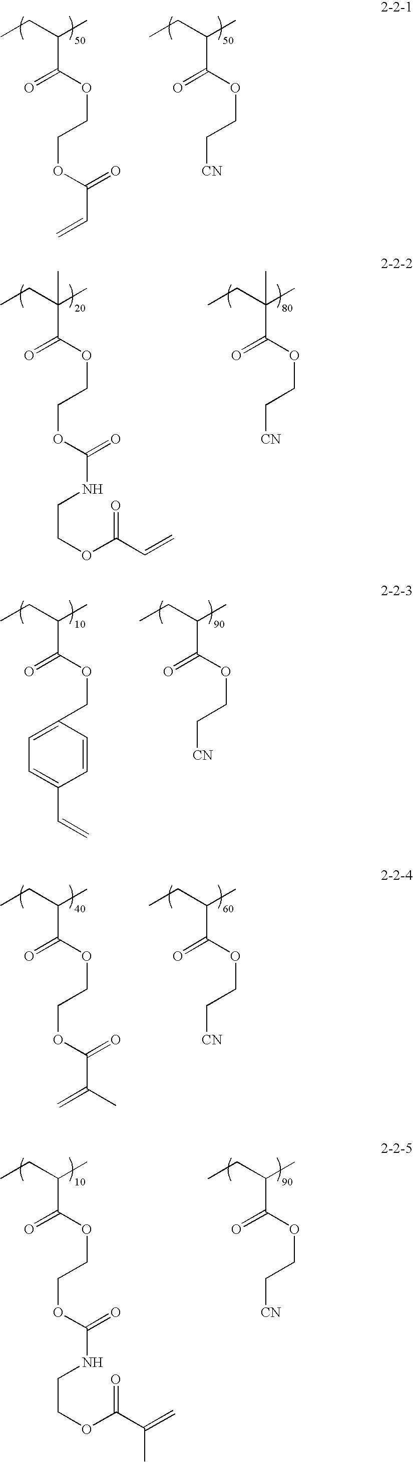

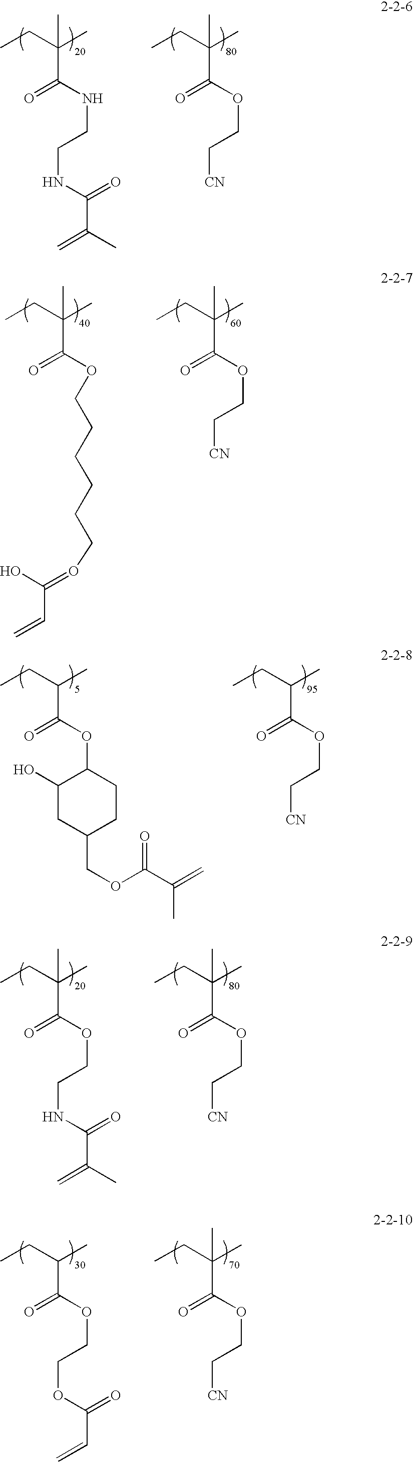

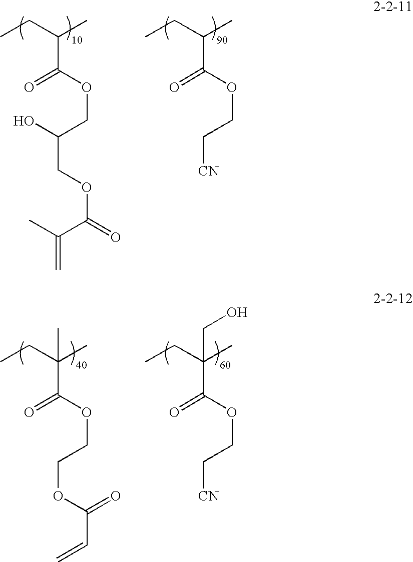

### Polymer Obtained by Embodiment 2-2

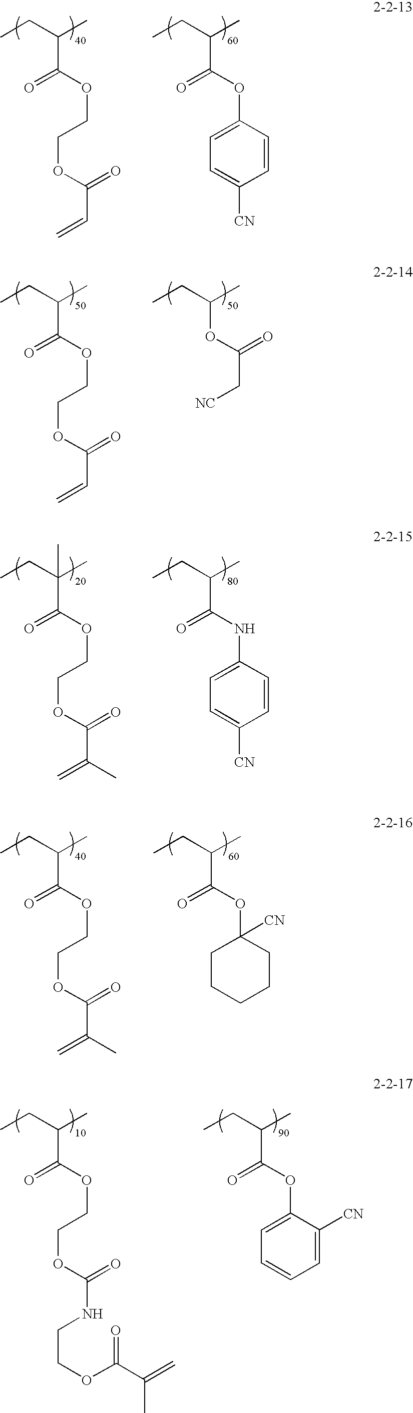

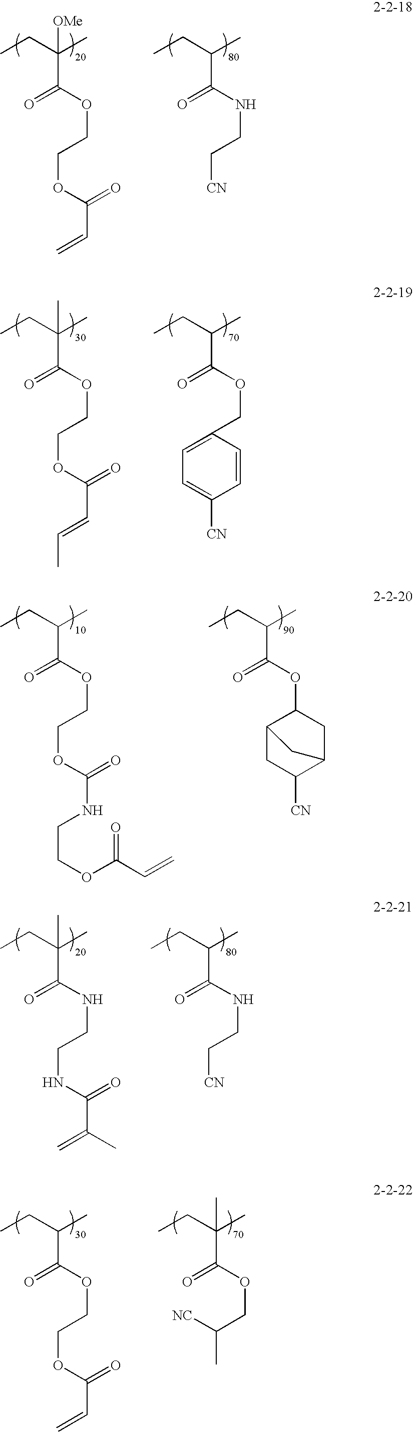

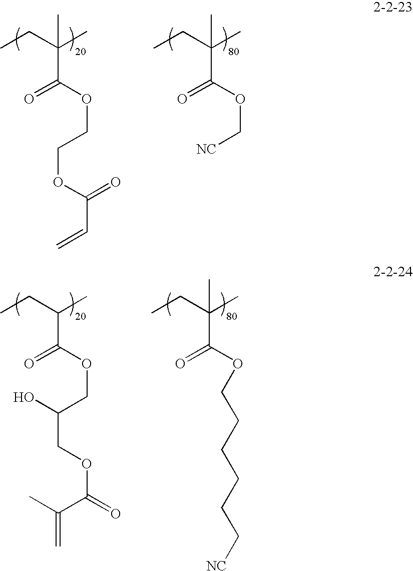

### Polymer obtained by Embodiment 2-2

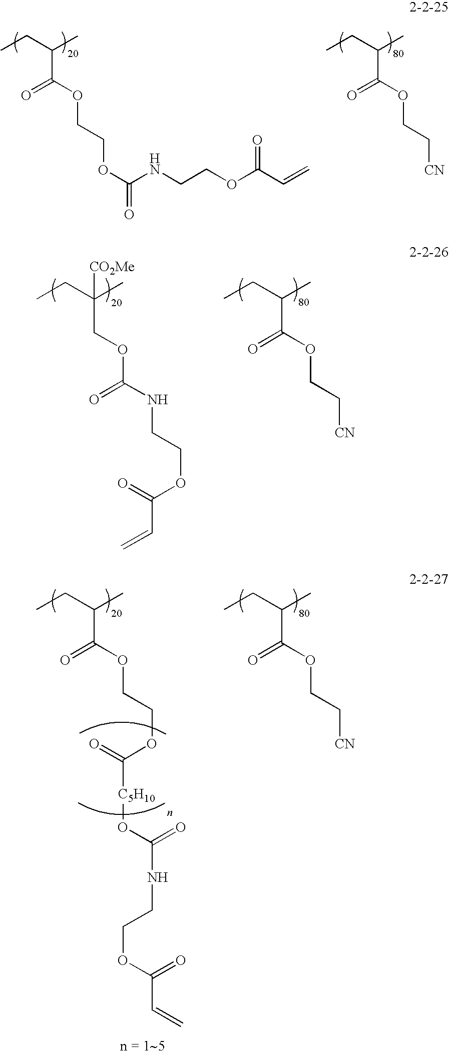

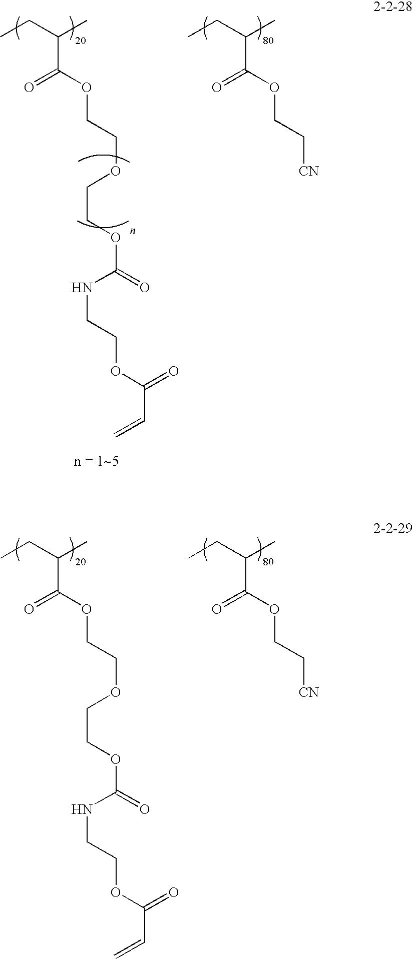

### Polymer Obtained by Embodiment 2-2

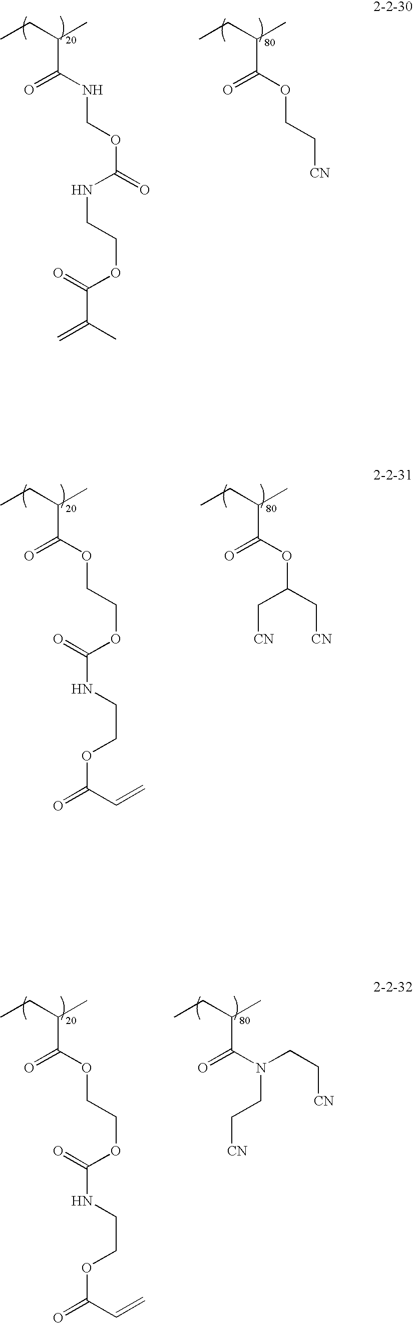

Here, for example, the compound 2-2-11 as a specific example above can be synthesized by dissolving acrylic acid and 2-cyanoethyl acrylate in N-methylpyrrolidine for example, and then subjecting the solution to radical polymerization with azoisobutyronitrile (AIBN) for example as a polymerization initiator, followed by addition reaction of glycidyl methacrylate and a polymerization inhibitor such as tertiary butyl hydroquinone, using a catalyst such as benzyltriethylammonium chloride.

Further, for example, the compound 2-2-19 as a specific example above can be synthesized by dissolving the monomer shown below and p-cyanobenzyl acrylate in a solvent such as N,N-dimethylacrylamide, then subjecting the solution to radical polymerization with a polymerization initiator such as dimethyl azoisobutyrate and then removing hydrochloric acid using a base such as triethylamine.

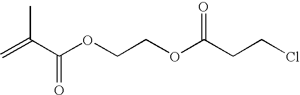

The compound having a polymerizable group and an interactive group such as the cyano group-containing polymerizable polymer and the like in the invention may have a polar group within a range in which the surface-hydrophobic cured material layer capable of receiving the formed plating catalyst or a precursor thereof in addition to the polymerizable group and the interactive group satisfies the requirements 1 and 2 to be described later.

If a metal film is formed by the step to be described later, and then for example, a protective layer is provided, by incorporating the polar group, then the adhesion force in the contact area between the polymer layer and the protective layer can be improved.

As described above, in order to form the surface-hydrophobic cured material layer in the invention, it is preferable to use a photosensitive resin composition containing a compound having a polymerizable group and an interactive group such as a polymer having a polymerizable group and an interactive group, and the like, that is, composition containing a compound having a polymerizable group and an interactive group, and a solvent which can dissolve the compound (preferably, a photosensitive resin composition containing a cyano group or a structure of —O—(CH₂)ₙ—O— (n is an integer of 1 to 5), a polymerizable group-containing polymer, and a solvent that can dissolve the compound).

When the specific polymerizable compound is a polymer, the weight average molecular weight is preferably from 1000 to 700000, and more preferably from 2000 to 300000. Particularly, from the viewpoint of the polymerization sensitivity, the weight average molecular weight is preferably 20000 or more. Further, for the polymerization degree, those having a 10-mer or more are preferably used, and those having a 20-mer or more are more preferably used. Further, those having a 7000-mer or less are preferable, those having a 3000-mer or less are more preferable, those having a 2000-mer or less are further preferable, and those having a 1000-mer or less are particularly preferable.

The content of the specific polymerizable compound (for example, the cyano group-containing polymerizable compound) is preferably in the range of 2% by mass to 50% by mass, and more preferably in the range of 5% by mass to 20% by mass, in terms of a solid content, relative to the photosensitive resin composition.

<Solvent>

For the photosensitive resin composition, a solvent may be used in addition to the specific polymerizable compound.

The solvent that can be used for the photosensitive resin composition of the invention is not particularly limited as long as it dissolves the compound having a polymerizable group and an interactive group that is a main component of the composition. A surfactant may be further added to the solvent.

Examples of the solvent that can be used include alcohol-based solvents such as methanol, ethanol, propanol, ethylene glycol, glycerin, propylene glycol monomethyl ether, and ethylene glycol dimethyl ether; acids such as acetic acid; ketone-based solvents such as acetone, methyl ethyl ketone, and cyclohexanone; amide-based solvents such as formamide, dimethylacetamide, and N-methylpyrrolidone; nitrile-based solvents such as acetonitrile and propionitrile; ester-based solvents such as methyl acetate and ethyl acetate; carbonate-based solvents such as dimethyl carbonate and diethyl carbonate, and the like.

Among these, when the cyano group-containing polymerizable polymer is used as the specific polymerizable compound, the amide-based solvents, the ketone-based solvents, the nitrile-based solvents, and the carbonate-based solvents are preferable, and specifically, acetone, dimethyl acetamide, methyl ethyl ketone, cyclohexanone, acetonitrile, propionitrile, N-methylpyrrolidone, and dimethyl carbonate are preferable.

Further, when the composition containing the cyano group-containing polymerizable polymer is coated, a solvent having a boiling point of 50 to 150° C. is preferred from the viewpoint of handleability. Further, the solvent may be used singly or in combination of two or more kinds thereof.

When the photosensitive resin composition of the invention is coated on a substrate, the solvent may be selected such that the solvent absorption of the substrate or the adhesion aiding layer provided thereon is from 5 to 25%. The solvent absorption may be determined by immersing the substrate or the base material having formed thereon the adhesion aiding layer into the solvent, and in 1000 minutes, measuring the mass variation before and after the immersion.

Further, in the case where the photosensitive resin composition is coated on the substrate, the solvent may also be selected such that the swelling ratio of the substrate is from 10 to 45%. The swelling ratio can be determined by immersing the substrate or the base material onto which the adhesion aiding layer has been formed in the solvent for 1000 minutes, and then measuring the thickness before and after the immersion.

Furthermore, when the photosensitive resin composition is diluted with a solvent to carry out the film formation by coating, it is possible to control the thickness of the foamed film by the content (% by weight) of the solid content in the coating liquid As its preferable concentration, the photosensitive resin composition is preferably diluted in the solvent at a total amount of the specific polymerizable compound and other solid additives in the range of 1 to 50% by weight, and particularly when forming a thin film having a thickness of 1 μm or less, the photosensitive resin composition is preferably diluted in the solvent in the range of 1 to 20% by weight to carry out the film formation.

The surfactant which may be added to the solvent as necessary may be any surfactant that is soluble in the solvent. Examples of such a surfactant include anionic surfactants such as sodium n-dodecylbenzenesulfonate, cationic surfactants such as n-dodecyltrimethylammonium chloride, nonionic surfactants such as polyoxyethylene nonylphenol ether (examples of commercially available products include EMULGEN 910 manufactured by Kao Corp., and the like), polyoxyethylene sorbitan monolaurate (examples of commercially available products include a trade name “TWEEN 20” and the like), polyoxyethylene lauryl ether, and the like.

In addition, a plasticizer may also be added to the photosensitive resin composition, if necessary. The plasticizer which can be used may be commonly-used plasticizers, and a solvent having a high boiling point such as phthalic acid esters (dimethyl phthalate, diethyl phthalate, dibutyl phthalate, di-2-ethylhexyl phthalate, di-normal-octyl phthalate, diisononyl phthalate, dinonyl phthalate, diisodecyl phthalate, butylbenzyl phthalate), adipic acid esters (dioctyl adipate, diisononyl adipate), dioctyl azelate, sebacic acid esters (dibutyl sebacate, dioctyl sebacate), tricresyl phosphate, tributyl acetylcitrate, epoxidized soybean oil, trioctyl trimellitate, chlorinated paraffin, dimethylacetamide, and N-methylpyrrolidone may be used.

Moreover, a polymerization inhibitor may be added to the photosensitive resin composition, if necessary. As the polymerization inhibitor which can be used, hydroquinones such as hydroquinone, ditertiary-butyl hydroquinone, 2,5-bis(1,1,3,3-tetramethylbutyl)hydroquinone, and the like, phenols such as p-methoxyphenol, phenol, and the like, benzoquinones, free radicals such as TEMPO (2,2,6,6-tetramethyl-1-piperidinyloxy free radical), 4-hydroxy-TEMPO, and the like, phenothiazines, nitrosoamines such as N-nitrosophenylhydroxyamine, an aluminum salt thereof, and the like, or catechols may be used.

In addition, other additives such as a rubber component (for example, CTBN, NBR, and the like), a flame retardant (for example, a phosphorus-based flame retardant), a diluent, a thixotropic agent, a pigment, a defoaming agent, a leveling agent, a coupling agent, and the like may be added.

By using a composition prepared by appropriately mixing the specific polymerizable compound and various additives, it is possible to optimize the physical properties of the surface-hydrophobic cured material layer which can receive the formed plating catalyst or a precursor thereof, such as the thermal expansion coefficient, glass transition temperature, Young's modulus, Poisson's ratio, rupture stress, yield stress, thermal decomposition temperature, and the like. In particular, it is preferred that the rupture stress, yield stress, and thermal decomposition temperature be as high as possible.

The thermal durability of the cured material layer thus obtained can be measured by a temperature cycle test, a thermal aging test, a reflow test, or the like. For example, with respect to the state of thermal decomposition, if the mass reduction after being exposed to an environment of 200° C. for 1 hour is 20% or less, it can be evaluated that the layer has sufficient thermal durability.

In the first step in the method of the invention, the respective components contained in such as photosensitive resin composition are dissolved in an appropriate solvent and adjusted, and coated on an appropriate substrate surface to form a photosensitive resin composition coating film.

When coating the photosensitive resin composition on the substrate, the coating amount is preferably from 0.1 to 20 g/m², and particularly preferably from 1 to 6 g/m², in terms of the solid content, from the viewpoint of achieving sufficient interaction properties with the plating catalyst or a precursor thereof.

When a coating liquid including the photosensitive resin composition is coated and dried to form a photosensitive resin composition layer, the layer may be left to stand at 20 to 40° C. for 0.5 to 2 hours to carry out a step of removing the residual solvent in the coating film, between the steps of coating and drying.

<(2) Step of Subjecting a Photosensitive Resin Composition to Pattern-Wise Exposure and Curing the Photosensitive Resin Composition to Form a Surface-Hydrophobic Cured Material Layer on an Exposed Area>

In a second step to be subsequently performed, a photosensitive resin composition coating film is subjected to pattern wise exposure to cure the exposed area, thereby forming a surface-hydrophobic cured material layer.

By this exposure step, in the exposed area, a specific polymerizable compound is chemically bonded directly to the substrate surface to form a region receiving the plating catalyst or a precursor thereof.

(Surface Graft)

The plating catalyst-receptive surface-hydrophobic cured material layer may be formed on the substrate by a measure that is called commonly-used surface graft polymerization. The graft polymerization is a method for synthesizing a graft (grafted tree) polymer, which includes providing an active species on a polymer compound chain and polymerizing an additional monomer, which is initiated with the active species. Particularly when the polymer compound to which the active species is given forms a solid surface, the method is called surface graft polymerization.

As the surface graft polymerization method that is applied in the invention, any of known methods as described in literatures can be used. For example, Shin-Kobunshi Jikkengaku 10 (New Polymer Experimentation 10), edited by the Polymer Society of Japan, 1994, published by Kyoritsu Publishing, p. 135 describes a photo-graft polymerization method and a plasma irradiation graft polymerization method for surface graft polymerization. Kyuchaku Gijutsu Binran (Adsorption Technology Handbook), reviewed by Takeuchi, published by NTS Inc. on February 1999, p. 203 and p. 695 also describes a method of irradiation graft polymerization with radiations such as a γ-ray, electron beams, and the like.

As specific methods of the photo-graft polymerization method, those as described in Japanese Patent Application Laid-Open (JP-A) Nos. 63-92658, 10-296895, and 11-119413 can be used.

When a surface-hydrophobic cured material layer (plating catalyst-receptive cured material layer) in the invention is formed, besides the surface grafting method, other methods including attaching a reactive functional group such as a trialkoxysilyl group, an isocyanate group, an amino group, a hydroxyl group, a carboxyl group, and the like to the end of the polymer compound chain and bonding it to the functional group present on the surface of the substrate by a coupling reaction may also be used.

Among these methods, the photo-graft polymerization method, in particular, a photo-graft polymerization method using an UV ray is preferably used to faun a surface-hydrophobic cured material layer, in which the specific interactive group-containing polymer is chemically bonded to the substrate, from the viewpoint of producing more quantity of graft polymers.

[Substrate]

The “substrate” in the invention refers to a substrate, a surface of which has a function to create a state in which a polymerizable compound having a functional group interactive with a plating catalyst or a precursor thereof can be chemically bonded directly to the surface. The base material itself constituting the substrate may have such surface characteristics, or an additional intermediate layer formed on the base material may have such characteristics.

(Base Material, Substrate)

As the base material used in the invention, the base material as described in [0062] of Japanese Patent Application Laid-Open (JP-A) No. 2007-154369 can be used. These base materials may be mixed with an inorganic filler such as silica and the like from the viewpoint of improving dimensional stability or physical characteristics, among which a base material including a resin made of an epoxy resin, a polyimide resin, or a liquid crystal polymer resin is preferable. Inorganic fillers may be mixed in these base materials from the viewpoint of improving dimensional stability or physical characteristics.

As the substrate in the invention, it is also possible to use the base material including a polyimide having a polymerization initiating site in its skeleton, described in paragraphs [0028] to [0088] of Japanese Patent Application Laid-Open (JP-A) No. 2005-281350.

Further, the substrate provided with a metal layer prepared by the method for preparing a substrate provided with a metal layer of the invention may be applied to a semiconductor package, various electrical wiring boards, and the like. For such applications, an insulating resin-containing substrate to be described below, specifically, a substrate composed of an insulating resin or a substrate having a layer including the insulating resin on a base material is preferably used.

Any known insulating resin composition is used to form a substrate composed of an insulating resin or a layer including an insulating resin. The insulating resin composition may use a resin as a main component in combination with various additives depending on the purpose. For example, a means in which a polyfunctional acrylate monomer may be added to the composition for the purpose of increasing strength of the insulating layer, a means in which inorganic or organic particles may be added to the composition for the purpose of increasing strength of the insulating material and improving electrical properties, or other means may be taken.

Further, the “insulating resin” in the invention means a resin having such a degree of insulating properties that it may be used for known insulating films or insulating layers. That is, any resin that is not a completely insulating material but has the required degree of insulating properties to meet the purpose may also be employed in the invention.

Specific examples of the insulating resin may include a thermosetting resin, a thermoplastic resin, or a mixture thereof. For example, an epoxy resin, a phenol resin, a polyimide resin, a polyester resin, a bismaleimide resin, a polyolefin-based resin, an isocyanate-based resin, a phenoxy resin, a polyether sulfone, a polysulfone, a polyphenylene sulfone, a polyphenylene sulfide, a polyphenyl ether, a polyetherimide, or the like, as described in [0014] to [0019] of Japanese Patent Application Laid-Open (JP-A) No. 2007-144820 can be used.

The insulating resin composition may also contain such a polymerizable double bond-containing compound, specifically, an acrylate or methacrylate compound, in particular, which is preferably polyfunctional, in order to promote crosslinking. As other examples of the polymerizable double bond-containing compound, a thermosetting resin or a thermoplastic resin, for example, an epoxy resin, a phenol resin, a polyimide resin, a polyolefin resin, a fluoro resin, and the like, which are partially (meth)acrylated with methacrylic acid, acrylic acid, or the like, may be used.

As the insulating resin composition in the invention, a composite (composite material) of a resin and other components to enhance properties such as the mechanical strength, heat resistance, weather resistance, flame retardancy, water resistance, electrical properties, and the like of the resin coating film can be used. Examples of materials used to form such a composite include paper, glass fibers, silica particles, a phenol resin, a polyimide resin, a bismaleimide triazine resin, a fluoro resin, a polyphenylene oxide resin, and the like.

In addition, the insulating resin composition may also contain, if necessary, one or more of fillers that are used for ordinarily-used wiring board resin materials, such as inorganic fillers such as silica, alumina, clay, talc, aluminum hydroxide, calcium carbonate, and the like, and organic fillers such as a cured epoxy resin, a crosslinked benzoguanamine resin, a crosslinked acrylic polymer, and the like. Among those, silica is preferably used as a filler.

Further, if necessary, the insulating resin composition may also contain one or more of various additives such as a colorant, a flame retardant, a tackifier, a silane coupling agent, an antioxidant, an ultraviolet absorber, and the like.

When these materials are added to the insulating resin composition, the content of any of these materials is preferably from 1 to 200% by mass, and more preferably from 10 to 80% by mass, based on the resin. If the content is less than 1% by mass, the materials are ineffective in enhancing the above-described characteristics. If the content is more than 200% by mass, the characteristics inherent to the resin, such as strength and the like, are degraded.

Specifically, the substrate for use in such applications is preferably a substrate composed of an insulating resin having a dielectric constant (relative dielectric constant) of 3.5 or less at 1 GHz, or a substrate having a layer including the insulating resin on the base material is preferred. Further, a substrate composed of an insulating resin having a dielectric loss tangent of 0.01 or less at 1 GHz or a substrate having a layer including the insulating resin on the base material is preferable.

The dielectric constant and the dielectric loss tangent of the insulating resin may be measured by conventional methods. For example, the measurement may be performed using a cavity resonator perturbation method (for example, with an ultra-thin sheet ∈r and tan δ meter manufactured by Keycom Corporation), based on the method described in “the Proceedings of 18^{th} Japan Institute of Electronics Packaging Annual Meeting”, 2004, p. 189.

As such, in the invention, it is also useful to select the insulating resin material from the viewpoint of the dielectric constant or the dielectric loss tangent as described above. Examples of the insulating resin with a dielectric constant of 3.5 or less and a dielectric loss tangent of 0.01 or less include a liquid crystal polymer, a polyimide resins, a fluoro resin, a polyphenylene ether resin, a cyanate ester resin, a bis(bisphenylene)ethane resin, and the like, as well as modified resins thereof.

The substrate used in the invention preferably has a surface roughness of 500 nm or less, more preferably 100 nm or less, even more preferably 50 nm or less, and most preferably 20 nm or less, taking consideration of applications to a semiconductor package, various electrical wiring substrates, or the like. The value of the surface roughness can be determined by an arithmetic average roughness Ra (JIS B0633-2001). The lower surface roughness of the substrate (or the lower surface roughness of the layer such as the intermediate layer or the polymerization initiating layer) is better, because the lower surface roughness can reduce the electrical loss during high-frequency transmission, when the resulting metal pattern material is used for wiring, or the like.

Further, it is possible to coat the photosensitive resin composition used in the invention on both sides of the substrate, allow the plating catalysts to be adsorbed by both sides, and then carrying out plating to form pattern-wise metal layers on both sides.

In addition, it is possible to form an adhesion aiding layer to be described below on the surface of a substrate, for the purpose of improving adhesiveness between a surface-hydrophobic cured material layer and the substrate.

### (Adhesion Aiding Layer)

The adhesion aiding layer is preferably formed by using a resin composition having good adhesiveness with a substrate and an active species (compound) that generates an active site capable of interacting with a resin film formed by a photosensitive resin composition. Furthermore, if the resin constituting the resin composition has a site that generates an active site capable of interacting with the resin film having a plating catalyst adsorbing capability, it is not necessary to add an active species (compound).

As for the adhesion aiding layer in the invention, for example, in the case where the base material is formed from a known insulating resin that is used in multilayer boards, build-up boards or flexible substrates, an insulating resin composition is preferably used as the resin composition used in the formation of the adhesion aiding layer from the viewpoint of the adhesiveness with the substrate.

In the following, an embodiment in which the base material is formed from an insulating resin and the adhesion aiding layer is formed from an insulating resin composition is described.

The insulating resin composition that is used in formation of the adhesion aiding layer may include the same insulating resin as the electrically insulating resin that constitutes the base material, or may include a different resin. However, the insulating resin composition that forms the adhesion aiding layer preferably includes an insulating resin having similar thermal physical properties, such as the glass transition temperature, elastic modulus or linear coefficient of expansion, to those of the electrically insulating resin that constitutes the base material. Specifically, for example, the same kind of insulating resins as the insulating resins that constitute the base material are preferably used in view of adhesion.

Further, inorganic or organic particles as other components may be used to increase strength of the adhesion aiding layer, and in addition, to improve electrical properties.

Furthermore, in the invention, the insulating resin that is used for the adhesion aiding layer refers to a resin having an insulating property of an acceptable level for use in known insulating films. Thus, any resin having an insulating property that meets the intended use is applicable in the invention, even if the resin is not completely insulating.

Specific examples of the insulating resin may include a thermosetting resin, a thermoplastic resin, or a mixture thereof. Examples of the thermosetting resin include an epoxy resin, a phenol resin, a polyimide resin, a polyester resin, a bismaleimide resin, a polyolefin-based resin, an isocyanate-based resin, and the like. Examples of the thermoplastic resin include a phenoxy resin, polyether sulfone, polysulfone, polyphenylene sulfone, polyphenylene sulfide, polyphenyl ether, polyether imide, and the like.

The thermosetting resins and the thermoplastic resins may be used singly or in combination of two or more kinds thereof.

As the insulating resin that is used in the adhesion aiding layer, it is also possible to use a resin having a skeleton that generates an active site capable of interacting with a plating catalyst-receptive photosensitive resin composition. For example, a polyimide having a polymerization initiating site in its skeleton as described in paragraph Nos. [0018] to [0078] of Japanese Patent Application Laid-Open (JP-A) No. 2005-307140 is used.

Further, the adhesion aiding layer may include a compound having a polymerizable double bond in order to promote the crosslinking in the layer, specifically an acrylate or methacrylate compound, and particularly a polyfunctional acrylate or methacrylate compound is preferably used. As other examples of the polymerizable double bond-containing compound, a thermosetting resin or a thermoplastic resin, for example, an epoxy resin, a phenol resin, a polyimide resin, a polyolefin resin, fluoro resin, and the like, each of which is partially (meth)acrylated with methacrylic acid, acrylic acid, or the like, may be used.

The adhesion aiding layer in the invention may include various compounds according to purposes to such an extent that the effects of the invention is not impaired.

Specific examples of such a compound include a substance capable of suppressing stress upon heating, such as rubber or SBR latex, a substance capable of improving film properties, such as a binder, a plasticizer, a surfactant, or a viscosity adjuster, and the like.

Moreover, a composite (composite material) of a resin and other component may also be used for the adhesion aiding layer in the invention to enhance properties of a resin film, such as mechanical strength, heat resistance, weather resistance, flame retardancy, water resistance, electrical properties, and the like. Examples of the material that may be used for producing a composite include paper, glass fiber, silica particles, a phenol resin, a polyimide resin, a bismaleimide triazine resin, a fluoro resin, a polyphenylene oxide resin, and the like.

In addition, the adhesion aiding layer may also contain, if necessary, one or more of fillers that are used for general wiring board resin materials, such as inorganic fillers such as silica, alumina, clay, talc, aluminum hydroxide, calcium carbonate, and the like, and organic fillers such as a cured epoxy resin, a crosslinked benzoguanamine resin, a crosslinked acrylic polymer, and the like.

Also, to the adhesion aiding layer, it is possible to add, if necessary, one or more kinds of additive, such as a colorant, a flame retardant, a tackifier, a silane coupling agent, an antioxidant, an ultraviolet absorbent, and the like.

When these materials are added, the content of any of these materials is preferably in the range of 0 to 200% by mass, and more preferably 0 to 80% by mass, relative to the amount of the resin as a main component. When the adhesion aiding layer and the base material that are adjacent to each other have the same or similar values of physical properties with respect to heat or electricity, these additives may not be added. When the above amount of the additive is more than 200% by mass, characteristics inherent to the resin, such as strength and the like, may be deteriorated.

The adhesion aiding layer preferably includes, as mentioned above, an active species (compound) that generates an active site capable of interacting with the photosensitive resin composition. Any type of energy may be applied, preferably such as light (such as an ultraviolet ray, a visible ray, an X ray, and the like), plasma (such as oxygen, nitrogen, carbon dioxide, argon, and the like), heat, electricity, and the like, in order to generate the active site. Further, it is also possible to generate an active site by chemically decomposing the surface of the adhesion aiding layer with an oxidative liquid (potassium permanganate solution) or the like.

Examples of the active species include the aforementioned thermal polymerization initiator or photopolymerization initiator that is added into the resin film (base material). Here, the amount of polymerization initiator contained in the adhesion aiding layer is preferably from 0.1 to 50 mass %, and more preferably from 1.0 to 30 mass % in terms of the solid content.

The thickness of the adhesion aiding layer in the invention is generally in the range of 0.1 μm to 10 μm, and preferably 0.2 μm to 5 μm. In the case of providing the adhesion aiding layer, if the thickness is within this general range, sufficient adhesion strength to the adjacent base material or the resin film having a metal ion adsorbing capability can be achieved. Further, when compared to the layer formed from an ordinarily-used adhesive, a similar level of adhesion to that of a layer formed from the ordinarily-used adhesive is achieved, even though the layer thickness is reduced. As a result, a film, both sides of which are provided with metal films, having small total thickness and excellent adhesiveness can be obtained.

Moreover, the surface of the adhesion aiding layer in the invention preferably has a surface roughness Rz of 3 μm or less, and more preferably 1 μm or less, as measured in accordance with a ten-point average height method as stipulated by JIS B0601 (1994), from the viewpoint of improving physical properties of the plated metal film to be formed. When the adhesion aiding layer has a surface smoothness within the above range, that is, a very high surface smoothness, the adhesion aiding layer is suitably used for the preparation of a printed wiring board having an extremely fine pattern (for example, a circuit pattern having a line/space value of 25/25 μm or less).

The adhesion aiding layer is formed on one side (side on which the photosensitive resin composition coating film is formed) of the resin film (base material) by employing a known layer-forming method such as an coating method, a transfer method, a printing method, and the like.

Moreover, the adhesion aiding layer formed on the substrate may be subjected to a curing treatment step by applying thereto a certain type of energy. Examples of the energy to be applied include light, heat, pressure, electron beams, and the like but heat or light is ordinarily used in this embodiment. In the case of heat, it is preferable to conduct heating at 100 to 300° C. for 5 minutes to 120 minutes. Further, the conditions for heating and curing may vary depending on the type of material for the resin film (base material), the type of resin composition that constitutes the adhesion aiding layer, or the curing temperatures of these materials, but are preferably selected from the range of 120 to 220° C. and 20 to 120 minutes.

This curing treatment step may be performed immediately after the formation of the adhesion aiding layer. Alternatively, by conducting a pre-curing treatment for about 5 minutes to about 10 minutes after the formation of the adhesion aiding layer, the curing treatment may be carried out after completion of all the other steps subsequent to the formation of the adhesion aiding layer.

After the formation of the adhesion aiding layer, the surface of the adhesion aiding layer may be roughened by a dry method and/or a wet method in order to improve its adhesiveness with the surface-hydrophobic cured material layer formed using a photosensitive resin composition on the surface of the adhesion aiding layer. Examples of the dry roughening method include mechanical polishing such as buffing, sand blasting, and the like, plasma etching, or the like. Further, examples of the wet roughening method include a chemical treatment such as a method using an oxidant such as permanganate, bichromate, ozone, hydrogen peroxide/sulfuric acid, nitric acid, and the like, a strong base, or a resin-swelling solvent.

(Exposure)

As a pattern-wise exposure means, a pattern-wise exposure means via a mask is generally used, but various types of laser scanning exposure may also be used.

Examples of the exposure light source include an UV lamp, a visible ray, or the like, or a mercury lamp, a metal halide lamp, a xenon lamp, a chemical lamp, a carbon arc lamp, and the like. Examples of radiations include electron beams, an X ray, ion beams, a far-infrared ray, and the like. In addition, a g-ray, a i-ray, a Deep-UV light, or high-density energy beams (laser beams) may also be used.

Examples of specific modes generally used preferably include scanning exposure using an infrared laser, high-illumination flash exposure using a xenon discharge lamp or the like via a mask, infrared lamp exposure, and the like.

The time required for exposure is generally from 5 seconds to 1 hour, although it varies depending on the binding property of a desired specific polymer to a substrate, the binding amount, and the optical intensity of the light source.

When the exposure power is selected taking into consideration such characteristics as facilitation of the surface graft polymerization, prevention of the decomposition of the produced graft polymer, and the like, the exposure power is preferably in the range of 10 mJ/cm² to 5000 mJ/cm², and more preferably 50 mJ/cm² to 3000 mJ/cm².

Further, a polymer having an average molecular weight of 20000 or more and a polymerization degree of 200-mer or more is used as the polymer having a polymerizable group and an interactive group, the graft polymerization may be readily proceeded upon low-energy exposure, and as a result, the decomposition of the produced graft polymer can be further inhibited.

In the plating catalyst-receptive surface-hydrophobic cured material layer formed by curing a photosensitive resin composition, the surface roughness due to non-uniform application is diminished after exposure and curing, and accordingly, the resin surface after curing the film gets extremely smooth. Even with the plating catalyst-receptive cured material layer having such as smooth surface, a strong and irreversible interaction of the coordination bonding properties with the plating catalyst is formed due to the function of the interactive group, and as a result, good adhesiveness with a metal film formed by performing plating based on the plating catalyst or the like adsorbed thereon can also be achieved.

<(3) Step of Removing the Uncured Material of the Photosensitive Resin Composition by Developer to Form a Patterned Surface-Hydrophobic Cured Material Layer>

The third step of the invention is a step of removing the uncured photosensitive resin composition in a portion on which the plating catalyst-receptive surface-hydrophobic cured material layer formed in the second step is not formed (unexposed portion).

By removing the uncured area in development, formation of the patterned plating catalyst-receptive surface-hydrophobic cured material layer is completed.

For the development, if the obtained surface-hydrophobic cured material layer immersed in, for example, an alkaline solution of pH 12, followed by stirring for 1 hour has a decomposition rate of the polymerizable group part of 50% or less, the highly alkaline solution can be used as a developer.

If the highly alkaline developer is used, the immersion time (development time) is from about 1 minute to 30 minutes.

Further, as another development method, a method in which a solvent (for example acetonitrile, acetone, and dimethyl carbonate) capable of dissolving the materials used for forming a plating catalyst-receptive cured material layer including a compound having a polymerizable group and an interactive group (cyano group), and the like is taken as a developer, and the plating catalyst-receptive cured material layer is immersed in the solvent, may be exemplified. The immersion time in the case of using the solvent is preferably from 1 minute to 30 minutes.

Also, when the surface-hydrophobic cured material layer including the cyano group-containing polymer as mentioned above in the preferred embodiment of the specific polymer is formed, the same method except that a compound containing a polymerizable group and a cyano group is used as a compound having a polymerizable group and an interactive group is employed, and further, the same applies to the preferred embodiment.

In the method of the invention, the compound constituting the patterned plating catalyst-receptive surface-hydrophobic cured material layer, which is obtained through the first step to the third step preferably has a cyano group as a functional group interactive with a plating catalyst or a precursor thereof. This cyano group has high polarity as described above, and has interaction of coordinate bonding with the plating catalyst or the like, and as a result, the cyano group has high adsorption capacity, but has neither good water absorbency nor good hydrophilicity as high as the dissociative polar group (hydrophilic group). The plating catalyst-receptive cured material layer including such a cyano group-containing specific polymer has low water absorbency as well as high hydrophobicity.

For this reason, the surface-hydrophobic cured material layer exhibits hydrophobicity, which satisfies the following Requirements.

Requirement 1: saturated water absorption under the conditions of 25° C. and a relative humidity of 50% is from 0.01 to 10% by mass

Requirement 2: saturated water absorption under the conditions of 25° C. and a relative humidity of 95% is from 0.05 to 20% by mass.

Hereinafter, each of the Requirements 1 and 2 will be described.

The saturated water absorptions in the Requirements 1 and 2, and water absorptions can be measured by the following methods.

First, the substrate is left to stand in a vacuum dryer, the moisture contained in the substrate is removed, and then left to stand in a constant temperature and humidity chamber set to the desired temperature and humidity. Thus, the change in the mass is measured to determine the water absorption. Here, the saturated water absorption in the Requirements 1 and 2 indicates the water absorption when the mass is not changed even after 24 hours has passed. Separately, for the laminate having the surface-hydrophobic cured material layer formed on the substrate which has been subjected to measurement of the saturated water absorption, the same procedure is carried out to measure the saturated water absorption of the laminate, thereby giving a difference between the saturated water absorption of the substrate and the saturated water absorption of the laminate, which can be used to measure the saturated water absorption of the surface-hydrophobic cured material layer. In any one of a case where the substrate has an adhesion aiding layer and a case where the substrate has no adhesion aiding layer, the same method can be used to measure the saturated water absorption. Further, while not applying the surface-hydrophobic cured material layer on the substrate, a single film of the photosensitive resin composition constituting the surface-hydrophobic cured material layer is prepared using a petri-dish or the like, and for the obtained polymer single film, the saturated water absorption can be directly measured according to the above-described method.

<(4) Step of Bringing the Aqueous Plating Catalyst Solution Containing the Plating Catalyst or Precursor Thereof and an Organic Solvent into Contact with a Substrate Having the Patterned Surface-Hydrophobic Cured Material Layer Formed Thereon>

In the fourth step of the invention, the substrate having the above-obtained pattern-wise surface-hydrophobic cured material layer formed thereon is immersed in an aqueous plating solution containing the plating catalyst or a precursor thereof and an organic solvent, to adsorb the patterned plating catalyst or precursor thereof.

In this step, the interactive group (cyano group) contained in the surface graft polymer constituting the surface-hydrophobic cured material layer attaches (adsorbs) the applied plating catalyst or the precursor thereof, according to the function of the interactive group.

Examples of the plating catalyst or precursor thereof to be applied include those that function as a catalyst or as an electrode for plating in the subsequent plating step (5) that will be described later. Therefore, the plating catalyst or precursor thereof is selected according to the type of plating performed in the plating step (5).

In general, the plating catalyst or a precursor thereof used in this step is preferably an electroless plating catalyst or a precursor thereof, but since the surface-hydrophobic cured material layer according to the invention can adsorb a sufficient amount of the plating catalyst, metalization of these adsorbed plating catalysts can be carried out by a reduction step, and then it is possible to carry out electroplating of a metal layer formed from the reduced metal as a conducting layer.

[Plating Catalyst Solution]

The aqueous plating catalyst solution of the invention which is preferably used in this step contains a plating catalyst or a precursor thereof and an organic solvent, which are suitably selected in the plating step.

First, the plating catalyst will be described.

((a) Electroless Plating Catalyst)

The electroless plating catalyst used in the invention may be any one as long as it functions as an active core during performing the electroless plating. Specific examples thereof include metals having a catalytic capability for a self-catalytic reduction reaction (Ni, or metals capable of electroless plating and having an ionization tendency that is lower than that of Ni), and the like, and specific examples thereof include Pd, Ag, Cu, Ni, Al, Fe, Co, and the like. Among them, those capable of multidentate coordination are preferred. From the viewpoints of the number of types of a functional group capable of coordination and superiority in the catalytic capability, Pd is particularly preferred.

This electroless plating catalyst may be usually used in the foam of a metal colloid. In general, the metal colloid may be produced by reducing metal ions in a solution containing a charged surfactant or a charged protective agent. The electrical charge of the metal colloid may be controlled by the surfactant or protective agent used herein.

((b) Electroless Plating Catalyst Precursor)

Any electroless plating catalyst precursor used in this step can be used without any particular limitation as long as it may function as an electroless plating catalyst by a chemical reaction. In general, metal ions of the metals mentioned above as the electroless plating catalyst are used. A metal ion that functions as an electroless plating catalyst precursor becomes a zero-valent metal that functions as an electroless plating catalyst through a reduction reaction. The metal ion as an electroless plating catalyst precursor may be converted into a zero-valent metal to obtain an electroless plating catalyst by performing a separate reduction reaction, after being applied to the polymer layer and prior to immersing in an electroless plating bath. Alternatively, the electroless plating catalyst precursor may be immersed in an electroless plating bath so as to be converted to a metal (electroless plating catalyst) while being immersed in the electroless plating bath by means of a reducing agent contained in the electroless plating bath. The electroless plating catalyst precursor may be used in the form of a metal complex.

Practically, the metal ion that is an electroless plating catalyst precursor is applied on plating catalyst-receptive cured material layer by using a metal salt. The metal salt to be used is not particularly limited as long as it can be dissolved in an appropriate solvent to dissociate into a metal ion and a base (anion). Specific examples thereof include M(NO₃)ₙ, MCln, M_{2/n}(SO₄), M_{3/n}(PO₄) (M represents an n-valent metal atom), and the like. A dissociated substance of the above-mentioned metal salts may be preferably used as the metal ion. Specific examples of the metal ion include an Ag ion, a Cu ion, an Al ion, a Ni ion, a Co ion, a Fe ion, and a Pd ion. Among them, those capable of multidentate coordination are preferred, and from the viewpoints of the number of types of a functional group capable of coordination and the catalytic capability, a Pd ion is particularly preferred.

((c) Other Catalysts)

In the invention, in the subsequent plating step (5) to be described below, a zero-valent metal may be used as the catalyst in order to directly performing electroplating to the plating catalyst-receptive cured material layer, which is provided with electrical conductivity by applying the plating catalyst at a high density, without performing electroless plating. Examples of the zero-valent metal include Pd, Ag, Cu, Ni, Al, Fe, Co, and the like. Among them, those capable of multidentate coordination are preferred, and from the viewpoints of the adsorbability (attachability) to the interactive group (cyano group) and the superiority in catalytic capability, Pd, Ag, and Cu are particularly preferred.

The amount of plating catalyst or a precursor thereof to be added to the plating catalyst solution is appropriately determined according to the purpose, but generally, it is preferably in the range of 0.01 to 10% by mass, more preferably in the range of 0.1 to 5% by mass, and most preferably in the range of 0.5 to 2% by mass. If the addition amount is within the above-described range, sufficient adsorption properties of the plating catalyst or a precursor thereof to a desired plating catalyst-receptive region and inhibition of adherence of the outer layer to the exposed area of the base material are balanced, and as a result, excellent selective plating catalyst adsorption is accomplished. Therefore, a high-precision pattern can be formed from the metal layer pattern formed by the subsequent plating step.

(Organic Solvent)

The aqueous plating catalyst solution of the invention contains an organic solvent. By incorporating this organic solvent, the penetration property into the hydrophobic cured material layer is improved, and the plating catalyst or a precursor thereof can be adsorbed efficiently into the interactive group contained in the cured material layer.

The solvent used for the preparation of the plating catalyst solution in this step is not particularly limited as long as it can permeate the cured material layer formed by the photosensitive resin composition. Since water is ordinarily used as a main solvent (dispersant) of the plating catalyst solution, the organic solvent is preferably a water-soluble organic solvent, that is, an organic solvent capable of uniformly dissolving at an arbitrary ratio with water. However, it is also generally possible to use a “non-aqueous” organic solvent if the solvent is dissolved within the range of the solvent content to be described below without limitation to the water-soluble organic solvent, as long as water is used as a main component for the plating catalyst solution.

For the embodiment, specific examples of the organic solvents include methyl acetoacetate, ethyl acetoacetate, ethylene glycol diacetate, cyclohexanone, acetylacetone, acetophenone, 2-(1-cyclohexenyl), propylene glycol diacetate, triacetin, diethylene glycol diacetate, dioxane, N-methylpyrrolidone, dimethyl carbonate, dimethyl cellosolve, and the like. From the viewpoint of compatibility with the plating catalyst or the precursor thereof, or the hydrophobic cured material layer, in particular, acetone, dimethyl carbonate, and dimethyl cellosolve are preferable.

Further, other examples of the organic solvent to be used in combination include diacetone alcohol, γ-butyrolactone, methanol, ethanol, isopropyl alcohol, n-propyl alcohol, propylene glycol monomethyl ether, methyl cellosolve, ethyl cellosolve, ethylene glycol tertiary butyl ether, tetrahydrofuran, 1,4-dioxane, n-methyl-2-pyrrolidone, and the like. In addition, the “non-water-soluble” solvent that is included in the solvent mentioned above may be mixed if the use amount of the solvent is an amount up to the solubility limit to water. For example, dimethyl carbonate may be mixed with water at an amount of up to 12.5%, triacetin may be mixed with water at an amount of up to 7.2%, and cyclohexanone may be mixed with water at an amount of up to 9%.

The content of the solvent is preferably from 0.5 to 40% by mass, more preferably from 5 to 30% by mass, and particularly preferably from 5 to 20% by mass, relative to the total amount of the plating catalyst solution. At the content of the solvent in the above-described range, the penetration of plating catalyst into the exposed area of the substrate (cured layer non-forming area), unwanted dissolution and erosion of the substrate are suppressed, but the penetration and adsorption properties of the catalyst solution into the inside of the surface-hydrophobic cured material layer having catalyst receptivity are maintained, and accordingly, the plating metal is precipitated not only on the outer surface but also in the inside around the outer surface of the cured material layer. Therefore, the adhesiveness of the interface between the base material and the metal is maintained good.

The aqueous plating catalyst solution used in the invention may contain other additives in accordance with purposes, in addition to the above-described essential components and water that is a main solvent, within a range not interfering with the effect of the invention.

Examples of the other additive include the followings:

For example, a swelling agent (organic compounds such as ketones, aldehydes, ethers, esters, and the like), a surfactant (anionic surfactants, cationic surfactants, amphoteric surfactants, nonionic surfactants, low-molecular surfactants, high-molecular surfactants, and the like), etc.

The water that is an essential component of the aqueous plating catalyst solution used in the invention and is a main solvent preferably includes no impurities, and from such a viewpoint, RO water, deionized water, distilled water, purified water, or the like is preferably used, and deionized water or distilled water is particularly preferably used.

In order to adsorb the metal that is a plating catalyst or a metal salt that is a plating catalyst precursor to the surface-hydrophobic cured material layer, the aqueous plating catalyst solution of the invention is prepared, and may be coated on a substrate surface having formed thereon a plating catalyst-receptive surface-hydrophobic cured material layer, or the substrate may be immersed in the catalyst solution.

Furthermore, in such an optional case that the plating catalyst-receptive surface-hydrophobic cured material layer is formed on both sides of the substrate, the above-described immersion method is preferably used so that the plating catalyst or a precursor thereof can be simultaneously brought into contact with the pattern-wise cured material layer present on both sides.

As mentioned above, by bringing the aqueous plating catalyst solution into contact with the substrate, the plating catalyst or a precursor thereof can be adsorbed to the interactive group (cyano group) in the surface-hydrophobic cured material layer by using interaction by means of an intermolecular force such as Van der Waal's force and the like, or interaction by means of a coordination bond by lone-pair electrons.

In view of sufficiently performing the adsorption, the concentration of the metal in the catalyst solution, the concentration of the metal ion in the catalyst solution, and the concentration of the organic solvent are preferably in the above-described ranges. In addition, the contacting time is preferably from about 30 seconds to 24 hours, and more preferably from about 1 minute to 1 hour.

(Washing)

In this regard, after adsorbing the plating catalyst or a precursor thereof to an interactive group in the pattern-wise surface-hydrophobic cured material layer, it is preferable to wash the substrate surface after bringing it into contact with the plating catalyst solution, in order to remove the excessive plating catalyst or a precursor thereof adhered to the surface-hydrophobic cured material layer or the exposed substrate surface.

Since the washing after catalyst adsorption is performed in order to remove the excessive plating catalyst or a precursor thereof which is adhered on the substrate surface but not adsorbed, particularly by interaction or the like, the surface may be washed with any liquid that remains on the substrate surface and does not affect the subsequent effects, such as water and the like. However, from the viewpoint of improving the efficiency of removal of adhered metal microparticles or metal ions, the same liquid like as the above-described aqueous plating catalyst solution except for containing contain neither plating catalyst nor a precursor thereof, that is, a washing liquid containing an organic solvent and water that is a main component is preferably used, and a washing liquid containing 0.5 to 40% by mass of the water-soluble organic solvent used in the preparation of the aqueous plating catalyst solution is more preferably used.

From the viewpoint that the plating catalyst precipitated on the exposed portion of the substrate (area having the surface-hydrophobic cured material layer not formed thereon) is eluted and removed effectively, it is particularly preferable to wash with a washing liquid containing water and an organic solvent at the same ratio as in the aqueous plating catalyst solution used in the fourth step.

In the substrate in which the excessive plating catalyst is removed by washing, the plating catalyst or a precursor thereof is adhered to the pattern-wise formed, surface-hydrophobic cured material layer, and adsorption of the plating catalyst or a precursor thereof is not substantially observed in the non-forming area, that is, the area having the substrate surface exposed thereon, whereby a patterned plating catalyst or a precursor thereof adsorption layer satisfying the following requirements is formed.

The difference in the adsorption amounts between the forming area and the non-forming area of the surface-hydrophobic cured material layers is defined by a value obtained when measurement is conducted using a plating catalyst solution containing palladium as a plating catalyst (palladium-containing test liquid) in the embodiment <1> of the invention, and is defined quantitatively by the following Requirement Formulae (A) and (B).

Specifically, when an aqueous plating catalyst solution containing 0.5% by mass of palladium acetate (a precursor compound of the catalyst) and an 20% by mass of organic solvent (acetone) is brought into contact with the substrate having the patterned surface-hydrophobic cured material layer formed thereon, the difference in the adsorption amounts between the forming area and the non-forming area of the surface-hydrophobic cured material layers is defined by A mg/m² and B mg/m², which refer to a palladium adsorption in an area having the surface-hydrophobic cured material layer formed thereon and a palladium adsorption in an area having the surface-hydrophobic cured material layer not formed thereon, respectively, which satisfy the following relationship Formulae (A) and (B):

10 mg/m²≦A≦150 mg/m² Formula (A)

0 mg/m²≦B≦5 mg/m². Formula (B)

<Measurement of Palladium Adsorption Amount>

The palladium adsorption amount which is indicative of the plating catalyst adsorption amount can be measured in terms of milligrams/square meters (mg/m²) by adsorbing a catalyst onto a base material having an unit area, quantifying the palladium concentration by a mass spectrometry device (ICP-MS), and dividing the adsorption amount in the unit area by the unit area, and the measured values are also applied to the values in the embodiment <1> of the invention.

In order to quickly progress the plating and to prevent the excessive palladium not contributing to the plating from remaining on the surface-hydrophobic cured material layer, it is more preferable to absorb palladium in the range of 10 mg/m² to 100 mg/m² as an palladium adsorption amount, and for development of strong adhesion between the surface-hydrophobic cured material layer and the plating metal, the adsorption amount is particularly preferably in the range of 10 mg/m² to 80 mg/m².

<Measurement of Absorption Amount of Plating Catalyst Solution>

For the absorption amount of the plating catalyst solution in the embodiment <3> of the invention, as described above, it is required that the solvent of the plating catalyst solution (palladium-containing test liquid) containing palladium as a plating catalyst has an absorption of 3% or more and less than 50%, relative to the weight of the surface-hydrophobic cured material layer, as well as an absorption of 0.1% or more and less than 2.0%, relative to the weight of the area having the surface-hydrophobic cured material layer not formed thereon. As the palladium-containing test liquid, an aqueous plating catalyst solution which contains 0.5% by mass of palladium acetate as a plating catalyst and from 5 to 20% by mass of an organic solvent (acetone) is used.

It is preferable that C (% by mass) and D (% by mass), which refer to an absorption of a solvent of the plating catalyst solution relative to the mass of the surface-hydrophobic cured material layer of the catalyst and an absorption of a solvent of the plating catalyst solution relative to the mass of the area having the surface-hydrophobic cured material layer of the plating catalyst not formed thereon, respectively, satisfy the following relationship Formula (C):

0.002<(D/C)<0.67 Formula (C)

Here, with respect to the absorption amount of the plating catalyst solution, a sample having a size of 3 cm×3 cm of the surface-hydrophobic cured material layer alone obtained by forming a surface-hydrophobic cured material layer having a thickness of 0.2 mm on the entire surface of the substrate surface having peeling property, such as Teflon (registered trademark) and the like, and then stripping it, and a sample having a size of 3 cm×3 cm of the adhesion aiding layer alone obtained by forming an adhesion aiding layer having a thickness of 0.2 mm on the entire surface of the substrate surface having peeling property, such as Teflon (registered trademark) and the like, and then stripping it are prepared, and then they are immersed in the same solvent as a solvent specifically used in the plating catalyst solution, and then a change in weight of the absorption amount is measured. Thus, the absorption amount at the time point when the weight is not changed even after 24 hours have passed is defined as the absorption amount. Further, in the embodiment in which the non-forming area of the surface-hydrophobic cured material layer does not have an adhesion aiding layer, measurement may be conducted using the substrate which has been cut to a size of 3 cm×3 cm as sample in the same manner as in the sample having the adhesion aiding layer. The component adhered to the surface of each sample is wiped off with a waste cloth, and an average value of ten sheets of specimens is employed to reduce the measurement error.

Furthermore, the absorption may be determined by measuring the weights of the substrate having the adhesion aiding layer and the substrate having the surface-hydrophobic cured material layer formed thereon, determining the weights of the adhesion aiding layer and the surface-hydrophobic cured material layer through the difference from the weights of the substrate, and calculating on the basis of the weights.

The absorption amount of the solvent of the plating catalyst solution, relative to the weight of the surface-hydrophobic cured material layer measured as above is required to be from 3.0% by mass to 50% by mass in the embodiment <3> of the invention, preferably from 3.0% by mass to 30% by mass, and particularly preferably from 3.0% by mass to 20% by mass. If the absorption amount (penetration amount) is within the above-described range, there is no concern that the absorption of the solvent becomes excessive, and thus surface-hydrophobic cured material layer is swollen to cause cracks, whereby the layer structure cannot be maintained. In addition, the penetration into the inside to an extent that allows the plating catalyst or a precursor thereof to be sufficiently adsorbed, and accordingly, even in the subsequent plating step, the plating metal is precipitated well, and thus, a strong adhesion force between the cured material layer and the plating metal can be obtained.

Further, in the case where the adhesion aiding layer is formed on the area having the surface-hydrophobic cured material layer not formed thereon, for example, here, the absorption amount of the solvent relative to the weight of the adhesion aiding layer is required to be 0.1% by mass or more and less than 2.0% by mass, preferably from 0.1% by mass to 1.5% by mass, and particularly preferably from 0.1% by mass to 1.0% by mass. If the absorption amount of the solvent is too high, there may be a case where the plating catalyst or the like is penetrated together with the solvent into the non-forming area of the cured material layer, and thus, interferes with pattern formation of the metal obtained after plating treatment.

<Method for Preparing a Substrate Provided with the Metal Layer>

By further plating the substrate having an area onto which the patterned plating catalyst or precursor thereof formed by the method for adsorbing a catalyst of the invention is adsorbed, a substrate provided with a patterned metal layer can be obtained.

<(5) Step of Performing Plating>

In the method for preparing a substrate provided with a metal layer of the invention, the method for adsorbing a catalyst of the invention including the first step through the fourth step is carried out, and then the (5) step of performing plating (plating step) is subsequently carried out. By plating the plating catalyst-receptive cured material layer to which the electroless plating catalyst or a precursor thereof has been applied, a plated film (metal layer) can be formed, thereby obtaining a substrate provided with a metal layer. The plated film thus formed has excellent electrical conductivity and adhesiveness with a substrate.

The type of plating to be performed in this step may be electroless plating, electroplating, and the like, which can be selected according to the function of the plating catalyst or a precursor thereof that has established interaction of coordination bonding with the plating catalyst-receptive surface-hydrophobic cured material layer in the above-described method of adsorbing a catalyst.

Namely, in this step, either electroplating or electroless plating may be performed with respect to the cured material layer to which the plating catalyst or a precursor thereof has been applied.

Among these, in the invention, it is preferable to carry out electroless plating from the viewpoint of forming a hybrid structure that occurs in the polymer layer, or improving the adhesiveness. In addition, in a more preferred embodiment, electroplating is performed subsequent to the electroless plating so as to form a plated layer with a desired thickness.

Hereinafter, plating that is preferably performed in this step will be described.

(Electroless Plating)

Electroless plating refers to an operation for precipitating a metal by means of a chemical reaction, using a solution in which the metal ions to be precipitated as a plated metal are dissolved.

The electroless plating in this step is carried out, for example, by washing the substrate to which the electroless plating catalyst has been applied with water to remove an excessive amount of electroless plating catalyst (metal), and then immersing the substrate in an electroless plating bath. A generally known electroless plating bath can be used as the electroless plating bath to be used herein.

Further, when the substrate to which the electroless plating catalyst precursor has been applied is immersed in the electroless plating bath in such a state that that the electroless plating catalyst precursor is adsorbed to or impregnated in the polymer layer, the substrate is washed with water to remove an excessive amount of the precursor (metal salts or the like), and then the substrate is immersed in the electroless plating bath. In this case, reduction of the plating catalyst precursor and the subsequent electroless plating are carried out in the electroless plating bath. Likewise, a generally known electroless plating bath may be also used as the electroless plating bath in this case.

Furthermore, reduction of the electroless plating catalyst precursor can also be carried out by preparing a catalyst activating solution (reducing solution) in a separate step prior to the electroless plating, apart from the embodiment in which the above-described electroless plating solution is used. The catalyst activating solution is a solution in which a reducing agent capable of reducing an electroless plating catalyst precursor (typically metal ions) to a zero-valent metal is dissolved, and the amount of the reducing agent is generally from 0.1% by mass to 50% by mass, and preferably from 1% by mass to 30% by mass. As the reducing agent, a boron-based reducing agent such as sodium borohydride and dimethylamine borane, or a reducing agent such as formaldehyde, hypophosphorous acid, and the like can be used.

As the ordinarily used composition of the electroless plating bath, 1. metal ions for the plating, 2. a reducing agent, and 3. an additive that enhances the stability of the metal ions (stabilizer) are contained as main components, in addition to a solvent. The electroless plating bath may further include a known additive such as a stabilizer for the plating bath and the like, in addition to the above components.

The solvent used in this plating bath preferably contains an organic solvent having high affinity for a polymer layer (polymer layer satisfying the requirements 1 and 2) which has low water absorbency and high hydrophobicity. The type or content of the organic solvent may be selected and adjusted according to the physical properties of the surface-hydrophobic cured material layer. Particularly, it is preferred that the higher the saturated water absorption in the requirement 1 of the cured material layer, the lower the content of the organic solvent. Specific embodiment is described below.

That is, in a case where the saturated water absorption is more than 0.5% by mass and 5% by mass or less in the requirement 1, the content of the organic solvent in the total solvent of the plating bath is preferably from 10 to 80%, and in a case where the saturated water absorption is from 0.01 to 0.5% by mass in the requirement 1, the content of the organic solvent in the total solvent of the plating bath is more preferably from 20 to 80%.

The organic solvent used in the plating bath is required to be soluble in water. From such a point of view, ketones such as acetone and the like or alcohols such as methanol, ethanol, isopropanol, and the like are preferably used.

As the type of a metal used in the electroless plating bath, copper, tin, lead, nickel, gold, palladium, and rhodium are known. Among these, from the viewpoint of electrical conductivity, copper and gold are particularly preferred.

Further, the optimal reducing agent and additive may be selected in combination with the metal. For example, the electroless plating bath of copper contains CuSO₄ as a copper salt, HCOH as a reducing agent, and additives such as a chelating agent that functions as a stabilizer of copper ions such as EDTA, a Rochelle salt, or the like, trialkanolamine, and the like. Further, the electroless plating bath of CoNiP contains cobalt sulfate or nickel sulfate as a metal salt, sodium hypophosphite as a reducing agent, and sodium malonate, sodium malate, or sodium succinate as a complexing agent. In addition, the electroless plating bath of palladium contains (Pd(NH₃)₄)Cl₂ as a metal ion, NH₃ or H₂NNH₂ as a reducing agent, and EDTA as a stabilizer. These plating baths may also contain other components than the above-described components.

As the plating solution, a commercially available product may be used, and examples thereof include THRU-CUP PGT manufactured by C. Uyemura & Co., Ltd., ATS ADCOPPER IW manufactured by OKUNO CHEMICAL INDUSTRIES, CO., LTD., and the like.

The film thickness of the plated film thus formed by the electroless plating may be controlled by adjusting the concentration of the metal ion in the plating bath, the immersion time in the plating bath, the temperature of the plating bath, or the like. From the viewpoint of electrical conductivity, the thickness of the plated film is preferably 0.5 μm or more, and more preferably 3 μm or more. However, when the plated film formed by electroless plating is further subjected to electroplating as a conductive layer, a film having a thickness of at least 0.1 μm or more should be applied uniformly.

Moreover, the immersion time in the plating bath is preferably from about 1 minute to 6 hours, and more preferably from about 1 minute to about 3 hours.

For the plated film thus obtained by electroless plating, by observing the cross-section by means of SEM, it may be confirmed that microparticles of the electroless plating catalyst or the plated metal are dispersed closely together inside the surface-hydrophobic cured material layer, particularly, around its surface, and further that the plated metal is precipitated on the cured material layer. Since the interface between the substrate and the plating film is in a hybrid state of the polymer and the microparticles, favorable adhesiveness between the cured material layer and the metal layer is achieved even when the interface between the organic layer (cured material layer) and the inorganic substance (catalyst metal or plated metal) on the substrate is smooth (for example, in the cured material layer according to the invention, Ra is 0.1 μm or less at an area of 1 mm²).

(Electroplating)

In this step, if the plating catalyst or the precursor thereof that has been applied in the fourth step functions as an electrode, electroplating can be carried out with respect to the patterned surface-hydrophobic cured material layer to which the catalyst or the precursor thereof has been applied.

Further, electroplating may be further carried out, subsequently to the above-described electroless plating, by using the formed plated film as an electrode. In this way, a further metal film having an arbitrary thickness can be readily formed based on the electroless plated film having excellent adhesiveness with the substrate. Therefore, since it is possible to form a metal film to a desired thickness in accordance with the purpose by carrying out electroplating after electroless plating, the metal film of the invention is favorably used in various applications.

As the electroplating method in the invention, a conventionally known method can be used. Further, examples of the metal used in the electroplating in this step include copper, chromium, lead, nickel, gold, silver, tin, zinc, and the like. From the viewpoint of electrical conductivity, copper, gold, and silver are preferred, and copper is more preferred.

Furthermore, the film thickness of the metal film obtained by the electroplating varies depending on the applications, and can be controlled by adjusting the concentration of the metal contained in the plating bath, the current density, or the like. Also, when used for typical electrical wiring or the like, the film thickness is preferably 0.5 μm or more, and more preferably 3 μm or more, from the viewpoint of electrical conductivity.

In the invention, by forming the metal or the metal salt derived from the above-described plating catalyst and plating catalyst precursor and/or the metal precipitated in the plating catalyst-receptive cured material layer by electroless plating as a fractal microstructure, the adhesiveness between the metal film and the plating catalyst-receptive cured material layer can be further improved.

With respect to the amount of the metal present in the plating catalyst-receptive cured material layer, even when the proportion of the metal in a region of from the outermost surface of the plating catalyst-receptive cured material layer to a depth of 0.5 μm, as determined by photographing a cross-section of the substrate under a metallographic microscope, is 5 to 50% by area, and the arithmetic mean roughness Ra (JIS B0633-2001) in the interface between the plating catalyst-receptive cured material layer and the metal is, for example, from 0.05 to 0.5 μm, so that the interface is smooth, a stronger adhesion force between the substrate and the metal layer is achieved.

By going through the respective step of the method for preparing a substrate provided with a metal layer of the invention, a substrate provided with a metal layer can be obtained. Further, by carrying out such a step on both sides of the substrate, a substrate provided with a metal layer having a metal film formed on both sides can be obtained.

The substrate provided with a metal layer obtained by the method for preparing a substrate provided with a metal layer of the invention has excellent smoothness of the surface-hydrophobic cured material layer that is an organic layer formed on the substrate surface, and further has a favorable adhesive force of the metal layer. As a result, the substrate can be used in various applications such as an electromagnetic wave shielding film, a coating film, a dual-layer CCL (copper clad laminate) material, an electrical wiring material, and the like. Particularly, the smoothness in the interface between the metal layer and the organic layer is improved, and thus, it can be said that the effect is remarkable when the substrate is used in the applications requiring high-frequency transfer to be secured.

The substrate provided with a metal layer obtained by the method for preparing a substrate provided with a metal layer of the invention has excellent adhesiveness of the metal layer formed on the plating catalyst-receptive cured material layer surface that is an extremely smooth organic layer, and has an effect of being readily prepared using little energy.

By the method of preparing a substrate provided with a metal layer of the invention, a substrate having a pattern-wise metal layer can be obtained.

The substrate provided with a metal layer obtained by the preparation method of the invention preferably has a metal film (plated film) locally or entirely on the surface of the substrate having a surface roughness of 500 nm or less (more preferably 100 nm or less). Furthermore, it is also preferable that the adhesiveness between the substrate and the metal pattern is 0.2 kN/m or more. That is, the preparation method of the invention is characterized in that although the surface of a substrate, and further the surface of a plating catalyst-receptive cured material layer that is an organic layer formed on the substrate are smooth, materials having excellent adhesiveness between the substrate and the metal layer (metal pattern) can be easily prepared.

Furthermore, the roughness of the substrate surface is a value measured by observing, by means of SEM, the cross-section of the substrate obtained by cutting the substrate in the vertical direction to the surface thereof, and the arithmetic average roughness Ra was measured in accordance with JIS B0633-2001.

By the method for preparing a substrate provided with a metal layer of the invention, a high-precision pattern to which the plating catalyst or a precursor thereof is adhered selectively and efficiently is formed, whereby a substrate having a metal layer pattern that is excellent in the adhesiveness with the substrate can be obtained with high-precision.

For this reason, the substrate is useful for the preparation of semiconductor chips, electromagnetic wave shielding films, various electrical wiring boards, flexible printed wiring substrates (FPC), COF, TAB, antennas, multilayer wiring boards, mother boards, or the like.

### Examples

Herein below, the present invention will be explained in details with reference to Examples, but the invention is not intended to be limited thereto. Further, “%” and “part” are based on the mass, unless otherwise specified.

### Example 1

### Preparation of Substrate

As the base material, a polyimide having a thickness of 125 μm (Kapton 500H: Du Pont-Toray Co., Ltd.) was used. The saturated water absorption of this base material under the conditions of 25° C. and a relative humidity of 50% was 1.0% by mass.

An insulating layer (adhesion aiding layer 1) was formed by coating the insulating composition having the following composition so as to be a thickness of 3 microns onto the base material by a spin coat method, and then leaving it to stand at 30° C. for 1 hour to remove the solvent, and then drying it at 170° C. for 60 minutes.

(Formation of Adhesion Aiding Layer 1)

20 parts by mass of a bisphenol A type epoxy resin (185 of an epoxy equivalent, EPICOAT 828 manufactured by Yuka-Shell Epoxy Company, Limited.), 45 parts by mass of an epoxy cresol novolac type resin (215 of an epoxy equivalent, EPICLON N-673 manufactured by DIC Corporation), and 30 parts by mass of a phenol novolac resin (105 of a phenolic hydroxyl group equivalent, PHENOLITE manufactured by DIC Corporation) were dissolved in 20 parts of ethyl diglycol acetate and 20 parts of Solvent Naphtha, by heating while stirring, and then cooled to room temperature. Thereafter, to the mixture, 30 parts by mass of a cyclohexanone varnish of a phenoxy resin formed from EPICOAT 828 and bisphenol S (YL6747H30, with a non-volatile content of 30% by mass and a weight average molecular weight of 47000, manufactured by Yuka-Shell Epoxy Company, Limited.), 0.8 parts by mass of 2-phenyl-4,5-bis(hydroxymethyl)imidazole, 2 parts by mass of pulverized silica, and 0.5 part by mass of a silicone anti-foaming agent were added, thereby obtaining an insulating composition.

As described above, an adhesion aiding layer 1 including the insulating composition was formed and then subjected to a curing treatment at 180° C. for 30 minutes, thereby obtaining a substrate A1. The surface roughness (Ra) of the substrate A1 was 0.12 μm.

[Formation of Surface-Hydrophobic Cured Material Layer]

(Synthesis of Polymer A Having Polymerizable Group and Interactive Group)

First, a polymer A having a polymerizable group and an interactive group was synthesized in the following manner.

20 mL of ethylene glycol diacetate, 7.43 g of hydroxyethyl acrylate, and 32.03 g of cyanomethyl acrylate were placed in a 500 ml three-neck flask and heated to 80° C., and a mixture of 0.737 g of V-601 and 20 mL of ethylene glycol diacetate were dropped thereto over 4 hours. After completion of dropping, the mixture was allowed to react for 3 hours.

0.32 g of ditertiary-butyl hydroquinone, 1.04 g of U-600 (manufactured by NITTO KASEI CO., LTD.), 21.87 g of KARENZ AOI (manufactured by SHOWA DENKO K.K.), and 22 g of ethylene glycol diacetate were added to the above reaction solution, followed by performing a reaction at 55° C. for 6 hours. Thereafter, 4.1 g of methanol was added to the reaction solution, followed by performing a reaction for 1.5 hours. After completion of the reaction, the reaction solution was subjected to re-precipitation with water and a solid was recovered, thereby obtaining 35 g of Polymer A that was a specific polymer having a nitrile group as an interactive group, in which the ratio of the polymerizable group-containing units:nitrile group-containing units was 22:78 (molar ratio). Further, the molecular weight was found to be Mw=82000 (Mw/Mn=3.4) in terms of polystyrene.

(Preparation of a Coating Solution)

The above-described specific polymer A (10 parts by mass) and acetonitrile (90 parts by mass) were mixed, while mixing and stirring, to obtain a coating solution having a solid content of 10%.

(Curing of the Plating Catalyst-Receptive Cured Material Layer)

The thus-prepared coating solution was coated on the resin layer of the substrate A1 so as to be a thickness of 1 μm by a spin coat method and dried at 80° C. for 30 minutes. Thereafter, the substrate was subjected to pattern-wise exposure at a line/space of 12.5/12.5 μm via a mask having a light penetrating portion made of quartz and the masking portion (unexposed portion) deposited with chromium, for 660 seconds, using a UV exposing machine (product number: UVF-502S, lamp: UXM-501MD, manufactured by SAN-EI ELECTRIC CO., LTD.) at an irradiation power of 1.5 mW/cm² (irradiation power measured by a UV integrated light intensity meter UIT150 with a light-receiving sensor UVD-S254, manufactured by Ushio Denki Co., Ltd.). Thereby, a surface-hydrophobic cured material layer formed of a pattern-wise specific polymer were formed on the insulating resin layer of Substrate A1. Here, the integrated exposure amount was 500 mJ/cm².

Thereafter, the substrate having the surface-hydrophobic cured material layer formed thereon was immersed in acetone for 5 minutes while stirring and then washed with distilled water.

By this, Substrate A2 having a patterned surface-hydrophobic cured material layer was obtained.

(Measurement of Physical Properties of Surface-Hydrophobic Cured Material Layer)

The physical properties of the patterned surface-hydrophobic cured material layer were measured in accordance with the afore-mentioned method. The results were as follows.
Saturated water absorption under the conditions of 25° C. and a relative humidity of 50%:1.2% by mass
Saturated water absorption under the conditions of 25° C. and a relative humidity of 95%:3.4% by mass

[Application of Plating Catalyst by Aqueous Plating Catalyst Solution]

20% by mass of an aqueous organic solvent (solvent name: acetone) and 0.5% by mass of palladium nitrate (catalyst precursor) were added to water in an amount relative to water, followed by stirring at 26° C. for 30 minutes. Thereafter, the undissolved substances were filtered through a microfilter (DISMIC-25 HP, manufactured by Advantech Co., LTD., pore size 0.45 μm) to obtain an aqueous plating catalyst solution. Substrate A2 having the patterned surface-hydrophobic cured material layer was immersed in the aqueous plating catalyst solution for 30 minutes, and then immersed in a washing solution containing 20% by mass of acetone relative to water to wash. Subsequently, the substrate was washed with water.

Here, the palladium adsorptions in an area having the surface-hydrophobic cured material layer formed thereon and in an area having the surface-hydrophobic cured material layer not formed thereon (substrate surface) were measured by the above-described means. As a result, it was confirmed that the palladium adsorptions were 80 mg/m² and 2.4 mg/m² respectively, which satisfy the following relationship Formulae (A) and (B):

10 mg/m²≦A≦150 mg/m² Formula (A)

0 mg/m²≦B≦5 mg/m². Formula (B)

<Electroless Plating>

Substrate A2 having the plating catalyst-receptive cured material layer, to which a plating catalyst had been applied as above, was subjected to electroless plating with an electroless plating bath having the following composition, using THRU-CUP PGT manufactured by C. Uyemura & Co., Ltd., at 26° C. for 30 minutes. The thickness of the obtained electroless copper plated film was 0.5 μm.

The preparation order and raw materials of the electroless plating solution were as follows.

| Distilled water | Approx. 60% | by volume |
|---|---|---|
| PGT-A | 9.0% | by volume |
| PGT-B | 6.0% | by volume |
| PGT-C | 3.5% | by volume |
| Formaldehyde solution* | 2.3% | by volume |

Finally, the total amount of the solution was adjusted to 100% by volume at a liquid level with distilled water.
*The formaldehyde solution was a formaldehyde solution (special grade) available from Wako Pure Chemical Industries, Ltd.

The obtained pattern was observed using an optical microscope (the formed microwiring was observed by means of Color 3D Laser Scanning Microscope, VK-9700 (manufactured by Keyence Corp.), and as a result, it was confirmed that the copper pattern with a line/space=13/12 μm was formed without defects.

(Evaluation of Surface Roughness)

The arithmetic average roughness Ra at the interface between the plating catalyst-receptive cured material layer and the metal layer (plated film) was measured using an SEM photograph (magnification 10000) of the cross-section in accordance with JIS B0633-2001, and was found to be 0.120 μm.

(Evaluation of Adhesiveness)

For evaluation of the adhesiveness, the procedures until electroless plating were carried out in the same manner as in Example 1 except that pattern exposure was not performed via a mask and the entire surface was exposed, and then electroplating was performed.

[Electroplating]

Subsequently, electroplating was performed for 20 minutes in a copper electroplating bath having the following composition, using the copper electroless plated film as a feeding layer under the condition of 3 A/dm². The thickness of the obtained copper electroplated film was 12.0 μm.

(Composition of Electroplating Bath)

| | | |
|---|---|---|
| Copper sulfate | 38 | g |
| Sulfuric acid | 95 | g |
| Hydrochloric acid | 1 | mL |
| Copper Gleam PCM (manufactured by Meltex Inc.) | 3 | mL |
| Water | 500 | g |

The polyimide substrate provided with the obtained plated copper was subjected to heat treatment at 170° C. for 1 hour.

The obtained plated film was measured in terms of 90° peel strength at a tensile strength of 10 mm/min with respect to a width of 5 mm using RTM-100 (manufactured by A & D Company, Limited). As a result, the peel strength was 0.73 kN/mm. If the measured value is 0.7 kN/mm or more, adhesion (adhesion strength) is ranked as “good”.

As a result, it is understood that in the substrate provided with a metal layer obtained by the method for adsorbing a catalyst and method for preparing a substrate provided with a metal layer of the invention, the plating catalyst is adsorbed selectively to only a desired plating catalyst-receptive surface-hydrophobic cured material layer and the adherence of the plating catalyst to the substrate surface having the cured material layer not formed thereon is prevented, whereby a high-precision metal layer pattern is formed, and thus, both the smoothness of the interface between the surface-hydrophobic cured material layer and the metal layer and the adhesiveness between the substrate and the metal layer are good.

### Example 2

Substrate B1 was obtained in the same manner as in Example 1 except that the adhesion aiding layer 1 formed in Example 1 was replaced with the adhesion aiding layer 2 formed by the following method. A patterned surface-hydrophobic cured material layer was formed in the same manner as in Example 1 except that Substrate B1 was used, thereby obtaining Substrate B2 having a surface-hydrophobic cured material layer pattern.

(Formation of Adhesion Aiding Layer 2)

A coating solution was prepared by mixing 11.9 parts by mass of JER 806 (bisphenol F-type epoxy resin: manufactured by Japan Epoxy Resins Co., Ltd.), 4.7 parts by mass of LA 7052 (PHENOLITE, curing agent: manufactured by DIC Corporation), 21.7 parts by mass of YP 50-35 EK (phenoxy resin, manufactured by Tohto Kasei Co., Ltd.), 61.6 parts by mass of cyclohexanone, and 0.1 part by mass of 2-ethyl-4-methyl imidazole (curing promotor), and then filtering the mixed solution by a filter cloth (mesh #200).

The coating solution was coated on the same base material as in Example 1 by a spin coater (rotated at 300 rpm for 5 seconds and then at 1500 rpm for 25 seconds), and then dried at 170° C. for 60 minutes to be cured. The thickness of the cured adhesion aiding layer 2 was 1.3 μm. The substrate having the cured adhesion aiding layer 2 formed thereon was designated as Substrate B1. The surface roughness (Ra) of the adhesion aiding layer of Substrate B1 was 0.12 μm.

(Measurement of Physical Properties of Surface-Hydrophobic Cured Material Layer)

The physical properties of the obtained patterned surface-hydrophobic cured material layer were measured by the afore-mentioned methods. The results were as follows.
Saturated water absorption under the conditions of 25° C. and a relative humidity of 50%:1.2% by mass
Saturated water absorption under the conditions of 25° C. and a relative humidity of 95%:3.4% by mass

The obtained Substrate B2 having the patterned plating-receptive cured material layer was immersed in an aqueous plating solution in the same manner as in Example 1, thereby adsorbing the plating catalyst.

Here, the palladium adsorptions in an area having the surface-hydrophobic cured material layer formed thereon and in an area having the surface-hydrophobic cured material layer not formed thereon (substrate surface) were measured by the above-described means. As a result, it was confirmed that the palladium adsorptions were 80 mg/m² and 2.2 mg/m² respectively, which satisfy the following relationship Formulae (A) and (B):

10 mg/m²≦A≦150 mg/m² Formula (A)

0 mg/m²≦B≦5 mg/m². Formula (B)

By this, Substrate B2 having the plating catalyst-receptive cured material layer to which the plating catalyst has been applied was subjected to electroless plating in the same manner as in Example 1, thereby obtaining a substrate provided with a patterned metal layer, and for the adhesiveness, the substrate was subjected to exposure at an entire surface and then to electroplating after electroless plating, thereby obtaining a substrate to which the copper layer has been applied on the entire surface. Evaluation was performed in the same manner as in Example 1.

As a result, the pattern-forming property equivalent to that in Example 1 was obtained.

The Ra of the interface between the surface-hydrophobic cured material layer and the metal layer (plated film), as determined from evaluation of the surface roughness, was 0.12 μm, and the adhesiveness was 0.75 kN/mm in terms of 90° peel strength.

### Examples 3 and 4

A substrate having a copper film was obtained in the same manner as in Example 1, except that the ratios of the solvents in the plating solution in Example 1 were replaced with those described in Table 1 below, and evaluation was performed in the same manner as in Example 1. The results are described in Table 1 below.

### Comparative Examples 1 to 3

A substrate having a copper film was obtained in the same manner as in Example 1, except that the ratios of the solvents in the plating solution in Example 1 were replaced with those described in Table 1 below, and evaluation was performed in the same manner as in Example 1. The results are described in Table 1 below.

TABLE 1

| | Catalyst | | Precipitation | Non-precipitation | |
|---|---|---|---|---|---|
| | and | | property of electroless | property of electroless | Adhesion |
| | addition | | plating in pattern | plating in non-pattern | strength |
| | amount | Solvent | portion (Pd amount mg/m²) | portion (Pd amount mg/m²) | (kN/mm) |
| Example 1 | Pd nitrate | Water/acetone = | O (80) | O (2.4) | 0.73 |
| | 0.5% | 80/20 | | | |
| Example 2 | Pd nitrate | Water/acetone = | O (80) | O (2.2) | 0.75 |
| | 0.5% | 80/20 | | | |
| Example 3 | Pd nitrate | Water/acetone = | O (35) | O (2.5) | 0.75 |
| | 0.5% | 90/10 | | | |
| Example 4 | Pd nitrate | Water/acetone = | O (12) | O (2.3) | 0.74 |
| | 0.5% | 95/5 | | | |
| Comparative | Pd nitrate | Water | O (7.0) | O (1.4) | 0.41 |
| Example 1 | 0.5% | | | | |
| Comparative | Pd nitrate | Water/acetone = | O (120) | X (30) | 0.77 |
| Example 2 | 0.5% | 20/80 | | | |
| Comparative | Pd nitrate | Acetone | O (160) | X (60) | 0.71 |
| Example 3 | 0.5% | | | | |

From the results of Table 1, it is understood that in the substrate provided with a pattern-wise metal layer obtained by the method for adsorbing a catalyst of the invention, even when the ratio of the solvent or the kind of the adhesion aiding layer on the substrate surface was changed, the plating catalyst is adsorbed selectively and preferentially to a desired plating catalyst-receptive surface-hydrophobic cured material layer and the adherence of the plating catalyst to the substrate surface having the cured material layer not formed thereon is prevented, whereby a high-precision metal layer pattern is formed, and thus, both the smoothness of the interface between the surface-hydrophobic cured material layer and the metal layer and the adhesiveness between the substrate and the metal layer are good. For evaluation of the non-precipitation property of the electroless plating in the non-pattern portion in Table 1, a case where the Pd adsorption amount is 5 mg/m² or less was denoted as O and a case where the Pd adsorption amount is more than 5 mg/m² was denoted as X.

On the other hand, in Comparative Examples, it is understood that either the adhesiveness or the pattern-forming property of the metal film was deteriorated, and accordingly, the two properties cannot be satisfied in combination.

<Evaluation of Solvent Absorption Amount in Plating Catalyst Solution>

For the substrate having the plating-receptive cured material layer used in Example 1, the solvent absorption amounts in the plating solutions were measured using the samples obtained by changing the solvents of the plating catalyst solutions in Example 1, 3, and 4. Further, the same evaluation was applied to Comparative Examples 1 to 3.

Here, for the absorption amount of the solvent in the plating catalyst solution, a sample in which a surface-hydrophobic cured material layer having a thickness of 0.2 mm was foamed by the same material as in Example 1 on the entire surface of the substrate surface and a sample having a size of 3 cm×3 cm of the adhesion aiding layer 1 having a thickness of 0.2 mm were prepared and these samples were immersed in the same solvents as for the plating catalyst solutions used in Examples 1, 3, and 4, and the absorption amounts were measured in terms of change in weight. Then, the absorption amount was defined at the time when it was confirmed that the weight was not changed even after a lapse of 24 hours. The component adhered to the surface was wiped off with a waste cloth, and an average value of ten sheets of specimens was taken as data of Examples to reduce the measurement error.

The results are shown in Table 2 below.

TABLE 2

| | Catalyst | | Solvent absorption | Solvent absorption | Absorption amount |
|---|---|---|---|---|---|
| | and its | | amount in pattern | amount in non-pattern | in non-pattern portion/ |
| | addition | | portion (saturated | portion (saturated | absorption amount in |
| | amount | Solvent | absorption amount) | absorption amount) | pattern portion |
| Example 1 | Pd nitrate | Water/acetone = | O (12.9%) | O (1.7%) | 0.13 |
| | 0.5% | 80/20 | | | |
| Example 3 | Pd nitrate | Water/acetone = | O (9.8%) | O (1.4%) | 0.14 |
| | 0.5% | 90/10 | | | |
| Example 4 | Pd nitrate | Water/acetone = | O (6.8%) | O (1.2%) | 0.18 |
| | 0.5% | 95/5 | | | |
| Comparative | Pd nitrate | Water | X (2.4%) | O (1.1%) | 0.46 |
| Example 1 | 0.5% | | | | |
| Comparative | Pd nitrate | Water/acetone = | O (32.8%) | X (22.5%) | 0.69 |
| Example 2 | 0.5% | 20/80 | | | |
| Comparative | Pd nitrate | acetone | O (36.2%) | X (25.2%) | 0.70 |
| Example 3 | 0.5% | | | | |

As such, in Examples of the invention, the adsorption amounts of the solvent to the surface-hydrophobic cured material layer and the adhesion aiding layer 1 were within the ranges according to the invention, and the solvent absorption of the plating catalyst solution is also carried out pattern-wise and selectively. According to these results and the evaluation results described in Table 1 above, it has been proved that in Examples satisfying such physical properties, both selective metal pattern-forming property and high adhesiveness between the cured material layer and the metal film are achieved.

On the other hand, it is understood that in Comparative Example 1 in which the solvent absorption amount of the surface-hydrophobic cured material layer is low and in Comparative Examples 2 and 3 in which the solvent absorption amount is excellent but the solvent absorption amount in the non-forming area of the surface-hydrophobic cured material layer is also high, the effect of the invention is not obtained and the achievement of the selective and appropriate absorption amount of the solvent is of benefit to the effect of the invention.

The disclosures of Japanese Patent Application Nos. 2007-338035 and 2008-108577 are incorporated herein by reference in their entireties.

All documents, patent applications, and technical standards described in the present specification are herein incorporated by reference to the same extent as if each individual document, patent application, and technical standard were specifically and individually indicated to be incorporated by reference.

1. A method for adsorbing a catalyst, comprising:
a step of applying, to a substrate, a photocurable composition which contains a compound having a polymerizable group and a functional group that is interactive with a plating catalyst or a precursor thereof, and that, when photo-cured, forms a surface-hydrophobic cured material satisfying the following Requirements 1 and 2;
a step of curing the photocurable composition by pattern-wise exposure, thereby forming a surface-hydrophobic cured material layer on the exposed area;
a step of removing uncured material of the photocurable composition with a developer to form a patterned surface-hydrophobic cured material layer; and
a step of bringing an aqueous plating catalyst solution containing a plating catalyst or a precursor thereof and an organic solvent into contact with the substrate having the patternedwise surface-hydrophobic cured material layer formed thereon,
wherein, when a palladium-containing test liquid is brought into contact with the substrate having the patterned surface-hydrophobic cured material layer formed thereon, A mg/m² and B mg/m², which respectively refer to a palladium adsorption in an area having the surface-hydrophobic cured material layer formed thereon and a palladium adsorption in an area not having the surface-hydrophobic cured material layer formed thereon, satisfy the following relationship Formulae (A) and (B):
Requirement 1: saturated water absorption under conditions of 25° C. and a relative humidity of 50% is from 0.01 to 5% by mass
Requirement 2: saturated water absorption under conditions of 25° C. and a relative humidity of 95% is from 0.05 to 10% by mass
10 mg/m²≦A≦150 mg/m² Formula (A)
0 mg/m²≦B≦5 mg/m². Formula (B)

2. The method for adsorbing a catalyst according to claim 1, wherein the plating catalyst or precursor thereof is palladium, silver, copper, nickel, aluminum, iron, or cobalt, or a precursor thereof.

3. A method for adsorbing a catalyst, comprising:
a step of applying, to a substrate, a photocurable composition which contains a compound having a polymerizable group and a functional group that is interactive with a plating catalyst or a precursor thereof, and that, when photo-cured, forms a surface-hydrophobic cured material satisfying the following Requirements 1 and 2;
a step of curing the photocurable composition by pattern-wise exposure, thereby forming a surface-hydrophobic cured material layer on the exposed area;
a step of removing uncured material of the photocurable composition with a developer to form a patterned surface-hydrophobic cured material layer; and
a step of bringing an aqueous plating catalyst solution containing a plating catalyst or a precursor thereof and an organic solvent into contact with the substrate having the patterned surface-hydrophobic cured material layer formed thereon,
wherein a solvent of a palladium-containing test liquid has an absorption of from 3% to 50% relative to the mass of the surface-hydrophobic cured material layer and an absorption of from 0.1% to less than 2.0% relative to the mass of an area not having the surface-hydrophobic cured material layer formed thereon:
Requirement 1: saturated water absorption under conditions of 25° C. and a relative humidity of 50% is from 0.01 to 5% by mass,
Requirement 2: saturated water absorption under conditions of 25° C. and a relative humidity of 95% is from 0.05 to 10% by mass,

4. The method for adsorbing a catalyst according to claim 3, wherein the plating catalyst or precursor thereof is palladium, silver, copper, nickel, aluminum, iron, or cobalt, or a precursor thereof.

5. The method for adsorbing a catalyst according to claim 3, wherein, in the step of bringing an aqueous plating catalyst solution containing a plating catalyst or a precursor thereof and an organic solvent into contact with the substrate having the patterned surface-hydrophobic cured material layer formed thereon, C (% by mass) and D (% by mass), which respectively refer to an absorption of palladium plating catalyst relative to the mass of the surface-hydrophobic cured material layer and an absorption of palladium plating catalyst relative to the mass of the area not having the surface-hydrophobic cured material layer formed thereon, satisfy the following relationship Formula (C):
0.002<(D/C)<0.67 Formula (C)

6. The method for adsorbing a catalyst according to claim 1, further comprising a step of forming, on a substrate, an adhesion aiding layer containing an active species which generates an active site capable of interacting with a film formed by the photocurable composition, prior to the step of applying the photocurable composition to the substrate.

7. The method for adsorbing a catalyst according to claim 1, wherein the organic solvent is water-soluble and its content relative to the total amount of the aqueous plating catalyst solution is from 0.5 to 40% by mass.

8. The method for adsorbing a catalyst according to claim 1, wherein the compound having the polymerizable group and the functional group that is interactive with a plating catalyst or a precursor thereof is a polymer having a polymerizable group and a functional group that is interactive with a plating catalyst or a precursor thereof.

9. The method for adsorbing a catalyst according to claim 1, wherein the functional group that is interactive with a plating catalyst or a precursor thereof is a nitrogen-containing functional group, an oxygen-containing functional group, or a sulfur-containing functional group.

10. The method for adsorbing a catalyst according to claim 1, wherein the functional group that is interactive with a plating catalyst or a precursor thereof is an ether group or a cyano group.

11. The method for adsorbing a catalyst according to claim 1, wherein the functional group that is interactive with a plating catalyst or a precursor thereof is a cyano group.

12. The method for adsorbing a catalyst according to claim 8, wherein the polymer having a polymerizable group and a functional group that is interactive with a plating catalyst or a precursor thereof is a copolymer containing a unit represented by the following Formula (1) and a unit represented by the following Formula (2): 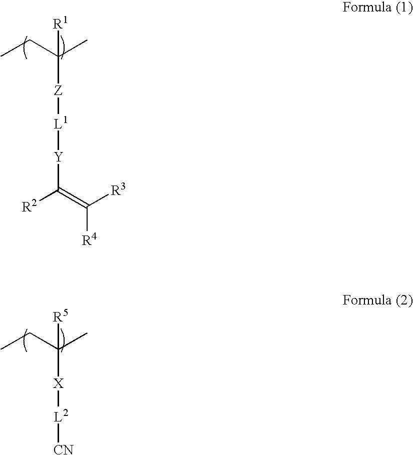
wherein, in Formulae (1) and (2), R¹ to R⁵ each independently represent a hydrogen atom or an alkyl group, X, Y, and Z each independently represent a single bond, a divalent organic group, an ester group, an amide group, or an ether group, and L¹ and L² each independently represent a divalent organic group.

13. A method for preparing a substrate provided with a patterned metal layer, comprising a step of non-electrically plating the substrate, formed by adsorption of the plating catalyst or a precursor thereof on the patterned surface-hydrophobic cured material layer, obtained by the method for adsorbing a catalyst according to claim 1.

14. The method for preparing a substrate provided with a patterned metal layer according to claim 13, further comprising electrical plating.

15. An aqueous plating catalyst solution, which is used in the method for adsorbing a catalyst according to claim 1, and comprises a plating catalyst and a water-soluble organic solvent.

16. A method for preparing a substrate provided with a patterned metal layer, comprising a step of non-electrically plating the substrate, formed by adsorption of the plating catalyst or a precursor thereof on the patterned surface-hydrophobic cured material layer, obtained by the method for adsorbing a catalyst according to claim 3.

17. The method for preparing a substrate provided with a patterned metal layer according to claim 16, further comprising electrical plating.

18. An aqueous plating catalyst solution, which is used in the method for adsorbing a catalyst according to claim 3 and comprises a plating catalyst and a water-soluble organic solvent.
